(19) United States
(12) Patent Application Publication
(10) Pub. No.: US 2011/0275518 A1
(43) Pub. Date: Nov. 10, 2011

(54) Compositions and Methods Comprising High Valency Silver for Increasing Seed Germination

(76) Inventors: Lyriam L. Marques, Edmonton (CA); Merle E. Olson, Calgary (CA); Michael W. Harding, Rosemary (CA)

(21) Appl. No.: 12/663,118

(22) PCT Filed: Jun. 9, 2008
(86) PCT No.: PCT/CA2008/001109

§ 371 Date: Jul. 21, 2010

Related U.S. Application Data
(60) Provisional application No. 60/942,477, filed on Jun. 7, 2007.

(51) Int. Cl. A01N 59/16; C01B 11/22; A01P 1/00; A01N 55/02; A01P 21/00; C01G 5/00; C07F 1/10

(52) U.S. Cl. 504/187; 423/395; 423/476; 556/36; 423/604; 504/190

(57) ABSTRACT

The present invention is compositions and methods for improving seed germination rates or speed using a composition comprising at least one high valency silver ion. The compositions and methods of the present invention are effective in treating biofilms.

This application claims priority from U.S. Provisional Application No. 60/942,477 filed on Jun. 7, 2007.

### I. FIELD OF INVENTION

This invention relates to compositions and methods for treating seeds. The compositions and methods are for preserving seeds and/or for treating, preventing or reducing microbial contamination of seeds. In some embodiments of the invention, the compositions and methods comprise an anti-biofilm agent for increasing the germination rate and/or the germination speed of seeds. The compositions and methods comprise at least one high valency silver ion. The compositions and methods do not inhibit seed germination.

### II. BACKGROUND

Plant diseases cause world-wide economic losses in all industries involving plant production such as agriculture, horticulture, floriculture, turf-grass, nursery crops and forestry operations. In addition, pathogens attack plant materials in post-harvest storages. Global economic losses due to plant diseases were estimated at 10%-15% reduction in potential production resulting in a cost of $76.1 billion between 1988 and 1990 (Orke et al., 1994; Pinstrup-Anderson, 2001). These infections in plants and produce are caused largely by microorganisms such as fungi, bacteria, viruses.

Another major concern in plant production is the occurrence of seed borne diseases. As an example, bacterial pathogens are a major problem in the production of dry bean (Phaseolus vulgaris) world-wide (Hirano and Upper, 1983; Singh and Munoz, 1999). Pathogens such as Pseudomonas syringae pv. syringae (brown spot), P. syringae pv. phaseolicola (halo blight), Xanthomonas axonopodis pv. phaseoli (common blight) and Curtobacterium flaccumfaciens pv. flaccumfaciens (wilt) cause serious losses in bean fields if the diseases are not managed. The use of certified disease-free seed is the first line of defense in preventing infections. Once diseases are introduced, the only method of control is the application of registered chemical pesticides.

There is a need for more effective and environmentally friendly methods and compositions for treating/protecting seeds from disease. There is also a need for such methods and compositions to comprise an anti-biofilm agent, to have a low level of toxicity, and to enhance seed germination. These methods and compositions would lower costs, increase the quality of seed and other plant material, increase customer satisfaction, promote industry growth, and help reduce the risk of seed-borne human infections such as those associated to sprouts.

It is known in the art to employ methods and compositions comprising silver as an anti-microbial agent. The prior art, however, teaches use of silver as an anti-microbial agent against solitary or planktonic cells and not as an anti-biofilm agent against microorganisms growing as biofilms. It is known that covering a growing plant with silver nitrate provides an anti-microbial effect, which helps protect the plant from disease. The traditional understanding, however, is that although a silver treatment could protect seeds from disease, such treatment may not work in practice because it may be deleterious to seed germination. Further, the prior art teaches that silver nitrate is phytotoxic [Ewell W S, Gorsuch J W, Ritter M, Ruffing C J, (1993) Ecotoxicological effects of silver compounds. Proceedings, 1^{st} Argencological International Conference on the Transport, Fate and Effects of Silver in the environment, Madison, Wis., USA, August 8-10, p9; Ratte HT Bioaccumulation and Toxicity of Silver Compounds. (1999) Environmental Toxicology and Chemistry 18: 89-1011.

Also, prior art such as U.S. Pat. No. 5,985,308 (Burrell) teach the use of high valency silver as an antibacterial agent, but the silver ion compositions described are unstable and have a short duration of activity. Further, there is no description of activity against biofilms.

Also, the prior art teaches using mono-valent silver as an anti-microbial agent but does not teach using silver of any higher valency.

There does not exist in the prior art, methods and composition comprising high valency silver ions for use as an antimicrobial and/or anti-biofilm agent to treat, prevent or reduce microbial contamination of seeds, including, but not limited to, microorganisms growing as biofilms on seeds, wherein such methods and compositions do not inhibit seed germination. There is also a need for such methods and compositions to help increase the germination rate and the germination speed of seeds.

### III. SUMMARY OF THE INVENTION

There is a need for methods and compositions for preserving seeds and/or for treating, preventing or reducing microbial contamination of seeds, including but not limited to preserving seeds and/or to treating, preventing or reducing microorganisms growing as biofilms on seeds. There is need for such methods and compositions to increase or beneficially affect seed germination and/or rate. There is also a need for preventing or reducing microbial contamination in or on soil around seeds, including by not limited to treating soil-borne disease and microorganisms.

Beneficial effect, as used herein, refers to any mechanism by which seed germination and/or rate is improved. For example, a beneficial effect could be the removal of a substance or chemical that retards seed germination. Or a beneficial effect may be the addition of a substance or chemical that promotes seed germination. Beneficial effect also includes improved or more efficient active agent delivery systems, e.g., using a coated seed to deliver an active agent to the soil. Beneficial effect also includes any benefit to a plant that grows from a seed treated in accordance with the present invention. Such beneficial effect includes but is not limited to preventing or decreasing a disease or deleterious microorganism in the growing or mature plant; enhanced or improved growing characteristics; and decreased need for nutrients, water, or anti-microbial agents.

The methods and compositions of the present invention employ at least one form of high valency silver as an active agent for mediating seed germination rate or speed.

The methods and compositions of the present invention can help preserve the seed and/or treat, prevent or reduce microbial contamination of the seed without significantly inhibiting seed germination.

The present invention further entails the surprising discovery that contacting the seed with high valency silver ions according the compositions and methods of this invention can increase the germination rate and/or the germination speed of the seed.

### IV. DESCRIPTION OF PREFERRED EMBODIMENT

The present invention comprises compositions and methods using one or more forms of high valency silver for affecting seed germination.

As used herein, affecting seed germination refers to increasing the germination rate, or increasing the germination speed, or both, of any seed. The present invention includes any composition and/or method that results in an improved germination rate and/or speed. For example, some embodiments of the invention result in an improvement by acting on or treating the seed itself. In other embodiments of the invention, the compositions and/or methods treat a microbe, biological substance, or chemical substance that inhibit, retard, or affect seed germination. For example, the inventors have found that treating a biofilm with a high valency silver ion containing composition of the present invention has the unexpected beneficial result of increasing the speed and rate of seed germination.

Germination rate, as used herein, refers to the percentage of seed population that undergoes germination. Germination speed, as used herein, refers to the time period required for a seed to undergo germination.

In some embodiments, method and the composition also do not inhibit seed germination. In other embodiments, the method and the composition of the present invention increase the germination rate and/or the germination speed of the seed.

The compositions and methods are anti-microbial, including but not limited to bactericidal, fungicidal, viricidal, algicidal, or parasiticidal. The method comprises treating, preventing or reducing microbial contamination of a seed by contacting said seed with an antimicrobial agent comprising at least one form of high valency silver. The composition comprises at least one form of high valency silver. The method and the composition may be used for treating a seed against planktonic microorganisms.

The present invention also comprises compositions and methods to treat, prevent or reduce one or more biofilms growing on a seed, using at least one form of high valency silver, such as for example but not limited to silver ions having Ag (II) and Ag (III) valent states. In one embodiment, the method comprises treating, preventing or reducing biofilm(s) on a seed by contacting the seed with an anti-biofilm agent comprising at least one form of a high valency silver. In one embodiment, the composition may comprise an anti-biofilm agent comprising at least one form of a high valency silver.

In one embodiment of the invention, the methods and compositions include as an active agent oxysilver nitrate (sometimes known as silver oxide nitrate). In preferred embodiments of the invention, the oxysilver nitrate is stable in an aqueous solution or suspension.

In one embodiment of the invention, the methods and compositions include as an active agent a stable silver salt comprising silver periodate. In preferred embodiments of the invention, the silver periodate is stable in an aqueous solution or suspension.

In one embodiment of the invention, the methods and compositions include as an active agent silver (II) biguanide, silver (III) biguanide, both either alone or in combination. In preferred embodiments of the invention, the biguanide is stable in an aqueous solution or suspension.

The present invention also comprises using the seed, or compositions containing the seed, for delivering an active agent. Delivering, as used herein, includes using the seed as a carrier or the like to expose or contact an active agent with a growing medium, such as soil or water.

The compositions and methods may also include one or more other active agents and/or additives. The method may further comprise contacting said seed with one or more additional anti-biofilm agents, preservatives and/or additional antimicrobial agents, each of which may comprise at least one form of high valency silver or comprise some other active agent or combinations. The composition may further comprise one or more additional anti-biofilm agents, additional preservative and/or additional antimicrobial agent, each of which may comprise at least one form of high valency silver or comprise some other active agent.

The invention also comprises contacting the seed with a composition comprising one or more antimicrobial and/or anti-biofilm agents, thereby extending storage life or preserving the seed. In some embodiments of the invention, the antimicrobial and/or anti-biofilm agent may reduce or eliminate seed surface contamination.

Formulations of the present invention may further comprise at least one ingredient selected from the group consisting of an active agent, a carrier, a surfactant, a dispersing agent, an anti-caking agent, and a foam-control agent.

In some embodiments of the invention, the compositions and methods may include applying the antimicrobial and/or anti-biofilm agent to any portion of a seed.

In accordance with some embodiments of the invention, any method of contacting the seed with an antimicrobial and/or anti-biofilm agent may be used. Typical mechanisms for contacting the seed include but are not limited to coating, spraying, immersing, and diffusing in liquid, gel, powder or other delivery forms.

Exemplary methods include but are not limited to watering, spraying, atomizing, scattering, spreading, dry dressing, wet dressing, liquid dressing, slurry treatment of seeds, incrustation, and combinations thereof. These and other methods are described in more detail in the examples, and in one or more of the following U.S. Patents, each incorporated herein by reference: U.S. Pat. Nos. 6,350,718; 6,557,298; 6,660,690; 7,081,436; 7,166,621; and 7,179,814.

For example, it may be applied, formulated or unformulated, to any part of the plant, including the foliage, stems, branches or roots, to the seed before it is planted or to other media in which plants are growing or are to be planted (such as soil surrounding the roots, the soil generally, paddy water or hydroponic culture systems), directly or it may be sprayed on, dusted on, applied by dipping, applied as a cream or paste formulation, applied as a vapour or applied through distribution or incorporation of a composition (such as a granular composition or a composition packed in a water-soluble bag) in soil or an aqueous environment.

A compound of formula (I) may also be injected into plants or sprayed onto vegetation using electrodynamic spraying techniques or other low volume methods, or applied by land or aerial irrigation systems.

The methods and compositions of the present invention may be used to treat a seed to eliminate or reduce one or more undesirable and/or deleterious microorganisms. The methods and compositions of the present invention may be used to prevent one or more undesirable or deleterious microorganism from infecting a seed. In these embodiments of the invention, the preservative compositions and methods may comprise an anti-microbial agent.

The methods and compositions of the present invention may be used to treat a seed to eliminate or reduce one or more undesirable and/or deleterious biofilms. The methods and compositions of the present invention may be used to prevent one or more undesirable or deleterious biofilms from infecting a seed. In these embodiments of the invention, the preservative compositions and methods may comprise an anti-biofilm agent.

The silver ion containing compositions of the invention may be comprised of silver ions and/or silver compounds having valent states higher than one, such as for example Ag (II) and Ag (III) valent states, may comprise a multivalent composition substance. Finally, it is believed that silver containing compositions produced using the methods of the invention may be comprised of a silver containing substance or a plurality of silver containing substances which react over time to form other silver containing substances which may exhibit differing antimicrobial properties. It is believed that if this is the case, the deposition products produced by the invention may be useful for providing a varied antimicrobial response and for overcoming microbial resistance.

These active silver species may include but are not limited to: oxidized silver species such as silver salts; silver oxide (Ag₂O); higher silver oxides i.e. Ag(II) and Ag(III) (AgO, Ag₂O₃, Ag₃O₄ or like); silver oxy-salts with a general formula Ag₇O₈X where X can include one of acid anions such as sulfates, chlorides, phosphates, carbonates, citrates, tartrates, oxalates and like; and silver organic complexes. The term “oxidized silver species” as used herein may involve but is not limited to compounds of silver where said silver is in +I, +II or +III valent states or any combinations thereof. These oxidized silver species include, for example silver (I) oxide, silver (II) oxide, silver (III) oxide or mixtures thereof, all silver salts having a solubility product higher than 10-20 (such as for example Ag₂SO₄, AgCl, Ag₂S₂O₈, Ag₂SO₃, Ag₂S₂O₃, Ag₃PO₄, and the like), and silver oxy-salts such as Ag₇O₈X were X can include but is not limited at NO³⁻, ClO⁴⁻, SO₄²⁻, F—.

The preferred composition of the present invention comprises an aqueous suspension of any form of silver that results in a high valency silver species. These active silver species may include at least one form of a high valency silver comprising an at least one form of soluble silver ion selected from the group consisting of, Ag++ and Ag+++. Compositions of the present invention may also include one or more soluble silver ions selected from the group consisting of Ag+, Ag++, and Ag+++.

The preferred methods and compositions of the present invention include oxysilver nitrate, silver periodate, silver II oxide, silver biguanide, and combinations thereof. Where the methods or compositions comprise at least one silver compound releasing Ag++, the compound may be selected from the group consisting of, but not limited to silver (II) oxide (AgO), high valency silver salts (Ag(Ag₃O₄)X where X═NO₃, ClO₄, F or HSO₄, (Ag₃O₄)₂SO₄, silver(II) sulfate (AgSO₄), silver bifluoride (AgF₂), Silver(II) periodate; organic complexes such as, but not limited to, (Agpy₄S₂O₈, silver ortho-phenanthroline, Agdipy₂, Agdipy₂(X)₂, where X═NO₃, ClO₄, Agdipy₃, Agdipy₃(X)₂, where X═NO₃, ClO₄, Agdipy₂(NO₃)₂.NO₃.HNO₃, (AgtripyNO₃)NO₃, silver(II) quinolate, silver(II) cinchomeronate, silver(II) isocinchomeronate, silver(II) lutidinate, silver(II) dipicolinate, silver(II) niconate, silver(II) isoniconate, silver(II) pyridine-2,4,6-3 carboxalate (black), silver(II) pyridine-2,4,6-3 carboxalate (brown), silver(II) pyridine-2,4,5-3 carboxalate, silver(II) biguanide, silver(II) benzalkonium chloride, silver(II) cetyldimethylethylammonium bromide, silver(II) ethylene biguanide.

Where the methods or composition comprise at least one silver compound releasing Ag+++, the compound may be selected from the group consisting of, but not limited to silver(III) fluorides [(BaAgF₅, MAgF₄ (M=K, Rb, Cs, N)], silver (III) periodate [Na₅H₂Ag(III)(IO₆)₂.H₂O], silver(III) tellurate, silver(III) ethylenebis (biguanide) [Ag(enbigH)₂X where X═SO₄, NO₃, ClO₄ or OH], silver(III) biguanide.

In other embodiments, the method or the composition may comprise silver (I, II, III) peroxide, colloidal silver, nanocrystaline silver or silver zeolite.

Methods of producing high valency silver ions are well known to those skilled in the art. An example of methods of producing high valency silver ions may be found in PCT/CA2007/001149, incorporated herein by reference. The silver deposition compounds may be used in any of the following formats: silver deposition coatings, liquid, powder, capsule, tablet, coating, and similar configurations.

A preferred embodiment of the present invention may also comprise a seed surface coating comprising at least one form of high valency silver as active agent, providing anti-biofilm properties, and this seed coating also comprising components that stabilize and control the release of the active agent into the surrounding environment when used.

In a preferred embodiment of the present invention, active agents are incorporated directly, or may be incorporated by sequentially adding components or precursors of the active agent to the seed coating, and having the precursors of the active agent in or on the coating. Other forms also include films, sheets, fibers, sprays and gels.

The preservative agents incorporated into the composition may be used for a variety of applications where there is a need for the presence of a preservative agent. A preferred use is in the treatment and preservation of seeds in both the agricultural and horticultural sectors, including but not limited to edible and fiber crops, produce, ornamental, nursery plants, fiber plants, forages, oilseeds, cereals, pulses, vegetables, medicinal plants, nutraceutical plants, and greenhouse crops.

The composition may also include additional antimicrobial agents, including but not limited to antifungal agents, antibacterial agents, anti-viral agents and anti-parasitic agents, growth factors, angiogenic factors, anaesthetics, mucopolysaccharides, and metals, disinfectants, antibiotics, cleaners, sanitizers, and other chemicals. Examples of antimicrobial agents that can be used in the present invention include, but are not limited to, -8-hydroxyquinoline sulfate, 8-hydroxyquinoline citrate, aluminum sulfate, quaternary ammonium, isoniazid, ethambutol, pyrazinamnide, streptomycin, clofazimine, rifabutin, fluoroquinolones, ofloxacin, sparfloxacin, rifampin, azithromycin, clarithromycin, dapsone, tetracycline, erythromycin, ciprofloxacin, doxycycline, ampicillin, amphotericin B, ketoconazole, fluconazole, pyrimethamine, sulfadiazine, clindamycin, lincomycin, pentamidine, atovaquone, paromomycin, diclazaril, acyclovir, trifluorouridine, foscarnet, penicillin, gentamicin, ganciclovir, iatroconazole, miconazole, Zn-pyrithione, heavy metals including, but not limited to, gold, platinum, silver, zinc and copper, and their combined forms including, salts, such as chloride, bromide, iodide and periodate, and complexes with carriers, and other forms, e.g., Biguanide.

These and other antimicrobial agents are described in more detail in the examples, and in one or more of the following U.S. Patents, each incorporated herein by reference: U.S. Pat. Nos. 6,350,718; 6,557,298; 6,660,690; 7,081,436; 7,166,621; and 7,179,814.

The composition may also include any known seed treatment, anti-microbial, and/or fungicidal products, including but not limited to Vitaflo 280, Apron-Maxx, Thiram. The composition may also include seed coatings, enhancers, emulsifiers, thickening agents, solvents, anti foaming agents, preservatives, fragrances, coloring agents, emollients, fillers, and the like. The composition may also include any rhizobial inoculant, including but not limited to Becker Underwood's Nodulator.

Exemplary seeds include, but are not limited to dry beans, pulse crops (e.g., peas, lentils, chickpeas, and fava beans), other legume crops (e.g., soybeans, alfalfa), seeds from cereals, e.g., wheat and barley; potato seeds, corn, oil seeds (e.g., canola and rapeseed), cotton, fruits, vegetables, herbs, spices, and ginseng seeds and seeds from other neutraceutical crops.

In this aspect of the invention, the compositions and methods are suitable for treating against one or more microbial infections, including but not limited to diseases or conditions caused by Pseudomonas spp., Xanthomonas spp., C. flaccumfaciens, S. sclerotium, Pythium spp, Fusarium spp; Brotrytis spp., Colletotrichum spp., H. solani; Streptomyces species, including scabies; Clavibacter species, Erwinia and other pectobacterium species; human pathogens associated with food safety including but not limited to Listeria species, Campylobacter species; Shigella species; E. coli strains, E. coli 0157, Salmonella spp., Staphylococcus spp., mycotoxin producing molds and fungal species such as Fusarium spp and Aspergillus spp. and parasites. Exemplary disease or conditions include, but are not limited to bacterial blight, brown spot, common blight, vascular wilt, white mold, gray mold, root rots, seed decay, damping off, head blight, silver scurf, dry rot, common scab, ring rot, soft rots, rusts, bunts, smuts, take-all, clubroot, and anthracnose.

These and other microbial infections are described in more detail in the examples, and in one or more of the following U.S. Patents, each incorporated herein by reference: U.S. Pat. Nos. 6,350,718; 6,557,298; 6,660,690; 7,081,436; 7,166,621; and 7,179,814.

The compositions and methods of the present invention are also effective, or expected to be effective, in decontaminating, disinfecting, or protecting a wide assortment of surfaces associated with the planting, harvesting, processing, and storing of seeds or produce. Exemplary surfaces include, but are not limited to agricultural surfaces, e.g., greenhouse, irrigation systems, storage facilities, and crates and bins; transport containers, agricultural tools and equipment, including harvesting and processing equipment, conveyor belts, pickers, seeders, and cutters; food processing plants, or equipment, fresh produce processing centers, and beverage processing centers.

As noted above, the compositions of the present invention may be in a wide variety of forms or formulations. Examples of these forms or formulations include but are not limited to coatings, gels, pastes, powders, suspensions and solutions (preferably aqueous). These and other formulations are described in more detail in the examples, and in one or more of the following U.S. Patents, each incorporated herein by reference: U.S. Pat. Nos. 6,350,718; 6,557,298; 6,660,690; 7,081,436; 7,166,621; and 7,179,814.As noted above, the compositions of the present invention may include or more additional active agents. In accordance with this aspect of the present invention, additional active agents may be formulated into a composition of the present invention, or may be applied to the seed or soil as a separate composition, either serially or in parallel, or may be applied to the seed or soil at a separate time.

Exemplary additional active agents include but is not limited to active agents disclosed in one or more of the following U.S. Patents (each incorporated herein by reference): U.S. Pat. Nos. 6,350,718; 6,557,298; 6,660,690; 7,081,436; 7,166,621; and 7,179,814.

As noted above, the compositions and methods of the present invention may include one or more additional ingredients. Exemplary additional ingredients include but is not limited to active agents disclosed in one or more of the following U.S. Patents (each incorporated herein by reference): U.S. Pat. Nos. 6,350,718; 6,557,298; 6,660,690; 7,081,436; 7,166,621; and 7,179,814.

As noted above, the active agents, compositions, and formulations of the present invention may be used as a seed coating, or the like, and/or may be used to deliver one or more active agents to the soil or medium in which the seed is grown. Exemplary coatings include but are not limited those disclosed in one or more of the following U.S. Patents (each incorporated herein by reference): U.S. Pat. Nos. 6,350,718; 6,557,298; 6,660,690; 7,081,436; 7,166,621; and 7,179,814.

### REFERENCES

Association of Official Seed Analysts. 1981. Rules for testing seeds. J. Seed Technol. 3:50.
Bailey, K. L., Gossen, B. D., Gugel R. K. and Morrall R. A. A. 2003. Diseases of Field Crop Crops in Canada, 3rd Edition. APS Press, Canada
Bashan, Y., Okon, Y., and Henis, Y. 1982. Long-term survival of Pseudomonas syringae pv. tomato and Xanthomonas campestris pv. vesicatoria in tomato and pepper seeds. Phytopathology 72:1143-1144.
Gilbert, J. and Tekauz, A. 1995. Effects of fusarium head blight and seed treatment on germination, emergence, and seedling vigour of spring wheat. Can. J. Plant Pathol. 17: 252-259.
Kuan, T. L., Minsavage, G. V., and Gabrielson, R. L. 1985. Detection of Xanthomonas campestris pv. carotae in carrot seed. Plant Dis. 69:758-760.
Mkandawire, A B C and Gilbertson R L 2001 Attempts to eradicate Xanthomonas campestris pv. phaseoli from bean seed using surface disinfection. Annu. Rep. Bean Improv. Coop, 44: 135-136.
Saskatchewan Pulse Growers. 2000. Pulse production manual. Saskatchewan Pulse Growers, Saskatoon, SK.
Remeeus, P. M. and Sheppard, J. W. 2006. Proposal for a new method for detecting Xanthomonas axonopodis pv. phaseoli on bean seeds. ISTA Method Validation Reports 3: 1-11.
Roumagnac, P., Pruvost, O., Chiroleu, F. and Hughes, G. 2003. Spatial and temporal analyses of bacterial blight of onion caused by Xanthomonas axonopodis pv. affii. Phytopathology, 94:138-146.
Schaad, N. W., and Kenkrick, R. 1975. A qualitative method of detecting Xanthomonas campestris in crucifer seed. Phytopathology 65:1034-1036.
Taylor, A. G., and Harman, G. E. 1990. Concepts and technologies of selected seed treatments. Ann. Rev. Phytopathol. 28:321-339.
Tubajika, K. M., Tillman, B. L., Russin, J. S., and Harrison, S. A. 1998. Relationship between flag leaf symptoms caused by Xanthomonas translucens pv. translucens and subsequent seed transmission in wheat. Plant Dis. 82:1341-1344.
Weller, D. M., and Saettler, A. W. 1980. Evaluation of seedborne Xanthomonas phaseoli and Xanthomonas phaseoli var. fuscans as primary inocula in bean blights. Phytopathology 70:148-152.
Xue. A. G., Warkentin, T. D., Greeniaus, M. T., and Zimmer, R. C. 1996. Genotypic variability in seedbourne infection of pea by Mycosphaerella pinodes and its relation to foliar disease severity. Can. J. Plant Pthol. 18: 270-374.

### EXAMPLES

### Example 1

### Evaluating of the Effects of High Valency Silver When Applied as an Aqueous Coating to Seeds of Various Dry Bean Cultivars

The efficacy of high valency silver nitrate as a seed treatment on diseased dry bean seeds was evaluated by looking at the effects of high valency silver applied as an aqueous seed coating on the germination of dry bean (Phaseolus vulgaris L).

High valency silver ions were prepared using known techniques, as follows: Silver nitrate (Ag(Ag₂O₄)₂NO₃) was prepared through the reaction of aqueous solutions of silver nitrate (AgNO₃) and potassium persulfate (K₂S₂O₈) to yield a black precipitate of pure silver nitrate (see chemical reaction below). The precipitate is recovered by filtration and the powder is dried.

7AgNO₃(aq)+K₂S₂O₈ (aq)+8 H₂O→Ag(Ag₂O₄)₂NO₃ (precipitate)+6HNO₃(aq)+6 H₂SO₄(aq)+K₂SO₄(aq)+4H₂(g)

Seeds were placed on blotters in Petri plates, were soaked in an excess of water for 3 days, then drained on day 4. The 3-day period of excess water created extremely high pressure from pathogenic and saprophytic bacteria. This led to a very high bacterial load on the germinating seeds and high disease pressure due to pathogenic, saprophytic and soft-rot bacteria. This disease pressure was so extreme that the germination rates for experiments 2-5 were essentially zero due to being overwhelmed by the disease pressure. However experiment #1 (a healthy seed lot of cultivar ‘Othello’) was able to overcome the disease pressure and to germinate significantly.

These extreme conditions were used to uncover the pronounced effectiveness of high valency silver against bacterial disease pressure. Under these conditions, high valency silver treatment significantly increase germination compared with a negative control (water) and a positive standard (Apron Maxx RTA).

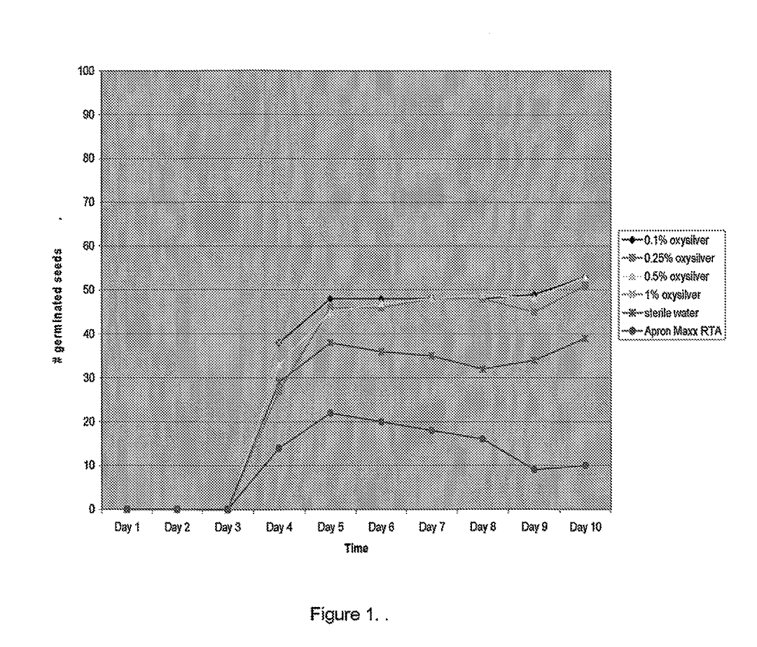

By day 10, the 1% high valency silver treatment increased germination by 34.7% compared with the negative control (sterile water). In addition, germination was 54% higher than Apron Maxx RTA—a registered seed treatment and industry standard for dry bean. The results are shown in Table 1 and graphically in FIG. 1. The treatments with high valency silver had no negative effects on germination as seen in the number of days needed to reach 25% germination. For example, phytotoxic compounds applied to seeds will delay or prevent germination. This will cause a longer time period required to reach 25% and/or 50% germination.

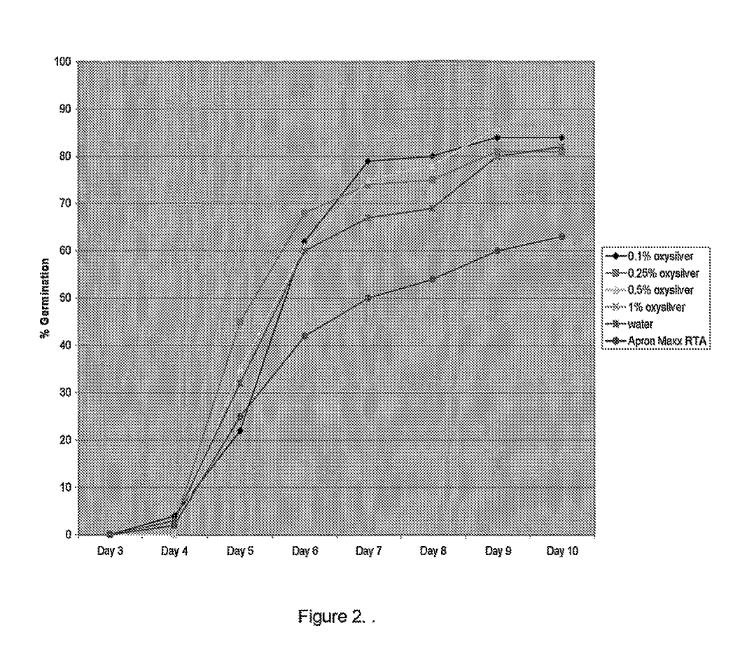

Furthermore, high valency silver increased the number of seeds germinated by 1.3- to 2.3-times. The positive effects of high valency silver can be visually observed in FIG. 2.

High valency silver is an excellent dry bean seed treatment because it has no phytotoxic effect on germinating seeds and can significantly rescue germination in seeds challenged with high numbers of contaminating bacteria. Specifically, it demonstrates that germination rates can be increased using high valency silver as a seed treatment, especially in lower quality seeds or poor germination conditions. It was also noted for other pulse crops that high valency silver treatment could accelerate germination (see Example 2), however no treatment in the experiment described herein led to accelerated germination of dry bean seeds.

Results of this experiment are shown in the following Table 1 and in FIG. 1.

TABLE 1
Germination results for Experiment 1.

| | # seeds | | Day to 25% |
|---|---|---|---|
| Treatment | germinated | % germination | germination |
| 0.1% high valency silver | 53 | 35.3 | 5 |
| 0.25% high valency silver | 51 | 43.0 | 5 |
| 0.5% high valency silver | 53 | 35.3 | 5 |
| 1% high valency silver | 91 | 60.7 | 5 |
| Sterile water | 39 | 26.0 | 5 |
| Apron Maxx RTA | 10 | 6.7 | n/a |

### Example 2

### Evaluation of Phytotoxicity of High Valency Silver on Pulse Crop Seeds (Pea Chickpea, Lentil, Soybean, Dry Bean)

This experiment determines whether the same high valency silver as that used in Example 1, when added to pulse seeds as an antimicrobial seed treatment, reduces germination, emergence or is phytotoxic to the pulse crops pea, chickpea, soybean and lentil. Germination data were recorded for seeds to which high valency silver was applied as an aqueous coating at one of four concentrations: 1000-ppm, 2500-ppm, 5000-ppm and 10000-ppm.

One hundred seeds each of five pulse crops (Table 2) were treated with the various concentrations of high valency silver (Table 3) and then sown (n=50 seeds) in non-sterile sandy soil in 5″ pots and placed in a greenhouse, or placed on a moist blotter (n=50 seeds) in sterile Petri plates. Germination on blotters was scored at 7- and 14-days. Emergence from soil was scored at 21- and 28-days. Germination and emergence of pulse seeds coated with high valency silver were compared with results for seeds treated with water, and seedlings were visually rated for any signs of phytotoxicity. Controlled variables for this experiment are summarized in Table 4.

To treat seeds, one hundred seeds were placed in a 50-mL Falcon tube and combined with the treatment solution. Seeds were mixed with the treatment for 5-min by gently rolling and inverting the Falcon tube. Coated seeds were placed in an open Petri plate for 30-min to dry. Seeds were sown 10-per pot, set in a greenhouse, and maintained under standard conditions with mercury lamp lighting supplementing daylight from 3:00 pm to 10:00 pm.

TABLE 2
Experimental factors for pulse germination and emergence trials.

| | |
|---|---|
| Experimental Factors | Treatments |

Pulse Seeds

| | |
|---|---|
| Al | Camry (Green Pea) |
| A2 | Myles (Dezi Chickpea) |
| A3 | Frontier (Kabuli Chickpea) |
| A4 | Plato (Large Green Lentil) |
| A5 | Orford (Soybean) |

Treatments and Checks

| | |
|---|---|
| B1 | 0.1% high valency silver |
| B2 | 0.25% high valency silver |
| B3 | 0.5% high valency silver |
| B4 | 1% high valency silver |
| B5 | Water |

TABLE 3
Treatment solutions and concentrations.

| | Concentration | Concentration |
|---|---|---|
| Treatment | (ppm) | (%) |
| high valency silver | 1000 | 0.1% |
| high valency silver | 2500 | 0.25% |
| high valency silver | 5000 | 0.5% |
| high valency silver | 10000 | 1% |
| Sterilized water | N/A | N/A |

TABLE 4
Experimental factors for pulse germination and emergence trials.

| | |
|---|---|
| Experimental Factors | Treatments |

Pulse Seeds

| | |
|---|---|
| Al | Camry (Green Pea) |
| A2 | Myles (Dezi Chickpea) |
| A3 | Frontier (Kabuli Chickpea) |
| A4 | Plato (Large Green Lentil) |
| A5 | Orford (Soybean) |

Treatments and Checks

| | |
|---|---|
| B1 | 0.1% high valency silver |
| B2 | 0.25% high valency silver |
| B3 | 0.5% high valency silver |
| B4 | 1% high valency silver |
| B5 | Water |

Preparation of Treatment Solutions:

10% solution—add 0.5-g of high valency silver to 5-mL of sterile water. Stir constantly.

5% solution—after the 10% solution has equilibrated for 15-min, add 0.5-mL of 10% solution to 0.5-mL of sterile water. Stir constantly.

2.5% solution—add 0.25-mL of 10% solution to 0.75-mL of sterile water. Stir constantly.

1% solution—add 0.1-mL of 10% solution to 0.9-mL of sterile water. Stir constantly.

Treatment of Pulse Seeds With High Valency Silver:

Place 100-seeds into a 50-mL Falcon tube and add 1-mL of treatment solution. Gently roll and invert the tube for 5 min to evenly coat each seed without causing damage. Remove seeds from tube by pouring carefully into an empty Petri plate. Leave exposed (lid off) and air dry seeds for 30 min.

Assessment of Germination and Emergence

(1) Germination: Place 50 seeds from each treatment onto 25 individual moistened blotters in large Petri plates. Incubate at room temperature for 2-weeks with or without light. Score germination at 7- and 14-days. (2) Emergence: Sow 50 seeds from each treatment into five pots (10-seeds per pot and five pots per treatment). Place in a greenhouse at 22° C. with ample air circulation. Use mercury lamps to supplement lighting (on at 3:00 pm-off at 10:00 pm) if necessary. For pre-emergent plants, water pots as needed to keep soil moist but not wet. Water emergent plants daily. Score emergence at 21 and 28 days.

Seeds were treated with water, or one of four concentrations of high valency silver and air dried in Petri plates. After seeds were treated and air-dried, they were sown in potted, non-sterile soil in a greenhouse. Alternatively they were placed on moist blotters in large Petri plates.

Germination of seeds on blotters was scored at 7-days (Table 5) and 14-days (Table 6). All soybean seeds had very slow and low rates for germination with many seeds un-germinated after 7-days and a maximum germination rate of 64%. Kabuli chickpea also had overall reduced germination rates for all treatments, including the control, although the reduction in germination for Kabuli chickpea was less severe than that for soybean.

The treatments with high valency silver had no negative effects on germination of any pulse seed in this experiment. On the contrary, seeds with heavy microbial loads (like soybean) showed increasing rates of germination directly related to increasing concentrations of high valency silver used to treat the seeds.

TABLE 5
Germination of pulse seeds. Scores are out of 50 seeds
that had been on blotters for 7-days.

| | | 0.1% | | | |
|---|---|---|---|---|---|
| | | high | 0.25% | 0.5% | 1% |
| | | valency | high valency | high valency | high valency |
| | Water | silver | silver | silver | silver |
| Chickpea | 45 | 47 | 45 | 44 | 45 |
| ‘Myles’ | | | | | |
| Chickpea | 42 | 40 | 45 | 48 | 47 |
| ‘Frontier’ | | | | | |
| Lentil | 48 | 46 | 46 | 49 | 42 |
| Pea | 43 | 46 | 48 | 48 | 47 |
| Soybean | 4 | 7 | 8 | 10 | 19 |

TABLE 6
Germination of pulse seeds. Scores are out of 50 seeds
that had been on blotters for 14-days.

| | | 0.1% | | | |
|---|---|---|---|---|---|
| | | high | 0.25% | 0.5% | 1% |
| | | valency | high valency | high valency | high valency |
| | Water | silver | silver | silver | silver |
| Chickpea | 44 | 44 | 46 | 47 | 45 |
| ‘Myles’ | | | | | |
| Chickpea | 34* | 45 | 41 | 48 | 45 |
| ‘Frontier’ | | | | | |
| Lentil | 48 | 49 | 48 | 49 | 47 |
| Pea | 47 | 45 | 46 | 48 | 46 |
| Soybean | 15 | 25 | 27 | 29 | 32 |

*Germination rates are reduced at 14-days (when compared to data at 7-days in Table 2) because some emerging hypocotyls were observed at 7-days and scored positive for germination. However, subsequent development was arrested and the hypocotyls never fully emerged. Therefore at 14-days these seeds were scored as a negative for germination.

### Example 3

### Enhancement of Germination by High Valency Silver

This experiment evaluates the enhancement of germination by high valency silver when applied to a Lower Quality Soybean Seed.

High valency silver was found to increase the speed and number of germinated soybean seeds. The speed of germination is seen in the percent germination after 7-days (Table 7). The water control reaches 26.7% by day seven but the high valency silver treatments reach 28%, 29.6%, 34.5%, and 59.4% respectively.

An increase in number of germinated seeds treated with high valency silver is seen when compared with water alone. After 14 days, the 1% high valency silver has a germination rate 34% higher than water (Table 8). The high valency silver treatments effectively double (or nearly double) percent germinated seeds.

Excessive bacterial growth was seen on the seeds and blotters from the water treated seeds while the high valency silver treated seeds did not appear to have major bacterial growth.

TABLE 7
Germination of pulse seeds. Scores are out of 50 seeds that had been
on blotters for 7-days.

| | | 0.1% high | 0.25% high | 0.5% high | 1% high |
|---|---|---|---|---|---|
| | | valency | valency | valency | valency |
| Day 7 | Water | silver | silver | silver | silver |
| Soybean | 4 | 7 | 8 | 10 | 19 |
| % of seeds | 26.7 | 28 | 29.6 | 34.5 | 59.4 |
| germinated | | | | | |

TABLE 8
Germination of pulse seeds. Scores are out of 50 seeds
that had been on blotters for 14-days.

| | | 0.1% high | 0.25% high | 0.5% high | 1% high |
|---|---|---|---|---|---|
| | | valency | valency | valency | valency |
| Day 14 | Water | silver | silver | silver | silver |
| Soybean | 15 | 25 | 27 | 29 | 32 |
| % | 30 | 50 | 54 | 58 | 64 |
| germination | | | | | |

### Example 4

### Healthy Dry Bean Seed

Healthy dry bean seed treated with high valency silver had more rapid germination (FIG. 2) and higher percent germination rate (Table 9) than water control or the industry standard ‘Apron Maxx RTA’. Additionally, the shortest time to 50% and 100% germination was seen in the high valency silver treatments (Table 9).

TABLE 9
Germination results for healthy dry bean seed.

| | # seeds | % | Day to 50% | Day to 100% |
|---|---|---|---|---|
| Treatment | germinated | germination | germination | germination |
| 0.1% high | 84 | 84 | 6.5 | 9.0 |
| valency silver | | | | |
| 0.25% high | 81 | 81 | 5.0 | 9.0 |
| valency silver | | | | |
| 0.5% high | 86 | 86 | 6.0 | 9.0 |
| valency silver | | | | |
| 1% high | 89 | 89 | 5.0 | 9.0 |
| valency silver | | | | |
| Sterile water | 82 | 82 | 6.0 | 10.0 |
| Apron Maxx | 63 | 63 | 5.5 | 10.0 |
| RTA | | | | |

### Example 5

### Seed Compatibility of Soybean Liquid Inoculant with Agress Seed Treatment

Objective: To determine the on-seed compatibility of the current Becker Underwood Soybean liquid formulation—Nodulator Liquid with a new wettable powder bactericide and fungicide seed treatment (a.i. oxysilver nitrate 79%)—Inc. Due to the indicated bactericidal nature of the product, Agress will be tested both as a simultaneous and sequential application—thereby minimizing exposure of the rhizobial cells expected in a tank mix!

Material and Methods

Nodulator Liquid (batch S256); Application rate: 2.74 ml/Kg Agress rate: 0.5 g+0.5 L water treats 100 Kg (prepared 0.01 g+0.01 L/2 Kg) Treated seeds are stored at 20C

Sequential Treatment

Nodulator Liquid+Agress: 5 ml Agress is applied to the seeds and allowed to dry prior to application of 2.74 ml Nodulator Liquid.

Simultaneous Treatment

Nodulator+Agress: 5 ml Agress was drawn into a syringe and then 2.74 ml Nodulator Liquid was drawn into the same syringe. Treatment is applied to seeds immediately.

Results:

Nodulator Liquid: 5.2×10⁹ cfu/ml

| | Cfu/seed at Days After Treatment | | |
|---|---|---|---|
| Assessment | Nodulator | | |
| Time | Liquid | Nodulator Liquid + | Nodulator Liquid + |
| (days) | (UTC) | Agress/Simultaneous | Agress/Sequential |
| T:0 | 1.1 × 106 | 1.2 × 106 | 1.5 × 106 |
| 1DAT | 7.3 × 105 | 4.8 × 105 | 4.1 × 105 |
| 2DAT | 6.9 × 105 | 3.3 × 105 | 3.9 × 105 |
| 3DAT | 6.5 × 105 | 3.0 × 105 | 3.5 × 105 |
| 4DAT | 5.0 × 105 | 2.5 × 105 | 3.0 × 105 |
| 7DAT | 3.7 × 105 | 2.0 × 105 | 2.1 × 105 |
| 14DAT | 2.6 × 105 | 1.2 × 105 | 1.0 × 105 |
| 21DAT | 1.7 × 105 | 4.5 × 104 | 5.8 × 104 |
| 28DAT | 1.2 × 105 | 2.3 × 104 | 2.4 × 104 |

Conclusion:

The in-pack and on-seed stability of the Nodulator Liquid are true to type, and therefore provides confidence in integrity of generated data.

Agress appears to be reasonably compatible with the Becker Underwood Soybean liquid, with a 14 day shelf life when applied either as a sequential or as a simultaneous application (compared to a 30 day shelf life with Nodulator Liquid). Becker Underwood's currently state the on-seed stabiity of Nodulator Liquid in Canada as 10 days, and this would be the same recommendation for Agress applied through either of these application systems (see below).

Summary of On-Seed Shelf Life Recommendations

Recommendation

| | Simultaneous | Sequential |
|---|---|---|
| Treatment | Treatment | Treatment |
| Nodulator Liquid | 10 Days | 10 Days |
| Nodulator Liquid + Agress | 10 Days | 10 Days |

### Example 6

### Compatibility Test Results for Agress+Apron Maxx (Syngenta)

### 1. Purpose:

to assess efficacy of Agress® to disinfest dry bean seed inoculated with Pseudomonas syringae pv. phaseolicola when used alone, or in combination with Apron Maxx RTA® and Apron XL®.
to assess the efficacy of Apron Maxx RTA® and Apron XL® to disinfest dry bean seed inoculated with Fusarium sp. when used alone or in combination with Agress®
   2. BACKGROUND: Seed rot/damping off and halo blight caused by Fusarium sp. and Pseudomonas syringae pv. phaseolicola respectively, are economically important diseases in dry bean producing areas. The diseases are seed-borne and therefore, effective seed treatment is an important aspect of disease management. Chemical treatments applied to the surfaces of seeds can eradicate bacterial and fungal seed-borne pathogens and disinfest seeds in preparation for planting. This project has two main objectives: 1) Evaluate the compatibility of Agress® when ‘tank mixed’ with seed treatment fungicides Apron Maxx RTA®or Apron XL® (Syngenta Crop Protection Canada Inc., Guelph, ON) at eradicating soil-borne diseases present on seeds artificially infested with Fusarium sp. 2) Evaluate the compatibility of seed treatment fungicides Apron Maxx RTA®or Apron XL®(Syngenta Crop Protection Canada Inc., Guelph, ON) when ‘tank mixed’ Agresewith at eradicating halo blight present in seeds artificially infested with P. syringae pv. phaseolicola

### 3. Materials

TABLE 1
Test microorganisms to be used.

| Microorganism | Host | Disease |
|---|---|---|
| Fusarium sp. | Phaseolus vulgaris L. (dry edible bean) | Seed rot |
| Pseudomonas syringae | Phaseolus vulgaris L. (dry edible bean) | Halo |
| pv. phaseolicola | | Blight |

TABLE 2
Dry bean cultivars seed to be used.

| Market Class | Cultivar |
|---|---|
| Pinto | ‘Othello’ |

TABLE 3
Treatment Materials and Concentrations.

| Treatment Material | Concentration |
|---|---|
| Sterile water (negative control) | n/a |
| Apron Maxx RTA - seed treatment fungicide | Ready-to-use |
| Agress (0.1%) - seed treatment bactericide | 0.1% |
| Apron Maxx RTA + 0.05% Agress | 0.05% Agress mixed in |
| | Apron Maxx RTA |
| Apron Maxx RTA + 0.1% Agress | 0.1% Agress mixed in |
| | Apron Maxx RTA |
| Apron Maxx + 1% Agress | 1% Agress mixed in |
| | Apron Maxx RTA |

### 4. Procedure

Growth of, and Inoculation with:

Fusarium sp.
Soak wheat grain overnight
Put 1—1.5 Litres of soaked grain into mushroom spawn bag
Autoclave the bags for 90 min. (sterilization time)
After the bags have cooled, inoculate with 3-6 pieces of inoculum from PDA plates.
Agitate the bags from time to time (every second or third day) so that the fungus will grow faster throughout the grain.
After the fungus has completely colonized the grain, spread the grain out to dry.
After the grain has dried completely, it can be ground to increase the number of colony forming units per gram of inoculum.
Store in a refrigerator for short term storage (up to 6 weeks).
Store in a freezer set anywhere between −15 and −30 for long-term storage—up to a year or more.

Pseudomonas Syringae pv. Phaseolicola
Growth of, and inoculation with, Pseudomonas syringae pv. phaseolicola is described in Innovotech protocol RD05-03-SEEDS-2006-07. Briefly, the bacterium is grown overnight in nutrient broth such that the population is in log phase growth or early saturation when seeds are inoculated. Bacterial counts should be >10⁹ cells/mL

### Preparation of Treatment Solutions.

Prepare sterile water by autoclaving distilled water at 121° C. and 18 psi for 15-min. Allow to cool
Apron Maxx RTA is a ready-to-use formulation—no dilution or mixing is required. Apply to seeds as per manufacturer's recommendations
Agress® is prepared by adding 1-gram of powder to 1-L of water (0.1% concentration)
Continue stirring for 30-min after adding powder to water
   Treatment of Pulse Seeds with Oxysilver Nitrate

Treatment of Seeds for Germination Trials:
1. Place 200-seeds into a zip lock bag add 1- to 2-mL of treatment solution.
2. Gently roll and invert seeds for 5-min to evenly coat each seed without causing damage.
3. Remove seeds from bad and air dry on bench.
4. Store in a sterile Petri plate or container.

### Germination and Emergence

1. Place 100 seeds from each treatment onto 4 individual moistened blotters in large Petri plates (25-seeds/plate and 4-plates per treatment).
2. Alternatively, place seeds onto King's B agar plates.
3. Incubate at 21° C. for 2-weeks in the dark.
4. Score germination daily for 14-days

### Conclusions

Mixing Agress with Apron Maxx RTA has no negative effects on germination. In fact, the only treatments with elevated germination rates were Agress+Apron Maxx RTA mixtures (0.05%-Agress+Apron Maxx RTA)
Mixing Agress with Apron Maxx RTA has no negative effects on emergence. In fact, the only treatments with elevated emergence rates were Agress+Apron Maxx RTA mixtures. (0.05%-Agress+Apron Maxx RTA and 1%-Agress+Apron Maxx RTA)
The ability of Agress to eradicate bacteria from seed surfaces is not significantly inhibited when mixed with Apron Maxx RTA.
The ability of Apron Maxx RTA to eradicate fungi from seed surfaces is not affected when mixed with Agress.
The ability of Agress to eradicate fungi from seed surfaces may be significantly enhanced when mixed with Apron Maxx RTA.
Plant vigour (fresh weight) is significantly improved when seeds are treated with 1%-Agress+Apron Maxx RTA.

### Example 7

### The “Current Treatment Matrix” Charts

Fungicides (some with insecticides)

| | Active | | |
|---|---|---|---|
| Product | Ingredient | Organism | Crops |
| Apron Maxx | Metalaxyl | Fusarium spp., Rhizoctonia | Beans - kidney, cranberry, |
| | Fludioxonil | spp., Pythium spp., | dry, chickpeas, field peas, |
| | | Phytophthora spp., | lentils, soybeans |
| | | Ascochyta spp. and seed- | |
| | | borne Colletotrichum spp. | |
| | | and Botrytis spp | |
| Apron XL | Metalaxyl | Pythium spp, Phytphthora | Beans - dry, green & |
| | | spp, downy mildew | others, corn, canola, |
| | | | chickpeas, field peas, |
| | | | forage grasses & legumes, |
| | | | lentils, oats, onions, rye, |
| | | | sainfoin, sorghum, |
| | | | soybeans, spinach, sugar |
| | | | beets, sunflowers, trefoil, |
| | | | turfgrass, leafy vegatables, |
| | | | wheat |
| Maxim 480 | Fludioxonil | Fusarium spp., Rhizoctonia | Corn, barley, oats, rye, |
| | | spp., Aspergillus, Penicillium, | wheat, flax, canola, |
| | | Phomopsis spp. | mustard, sunflower, |
| | | | soybeans, legumes |
| Maxim XL | Metalaxyl | Fusarium spp., Pythium spp., | Corn |
| | Fludioxonil | Rhizoctonia spp., | |
| | | Aspergillus, Penicillium, | |
| | | Phomopsis spp. | |
| Maxim MZ | Fludioxonil | Rhizoctonia solani, | Potato |
| PSP | Mancozeb | Helminthosporium solani, | |
| | | Fusarium spp | |
| Dividend XL | Difenoconazole | Pythium spp., Fusarium spp., | Wheat, barley, oats, rye, |
| RTA | Metalaxyl-M | septoria spp., cochliobouls | triticale |
| | | spp. | |
| Helix | Thiamethoxam | Leptosphaeria maculans, | Canola & other oilseeds |
| | Difenoconazole | Alternaria spp., Pythium | |
| | Metalaxyl | spp., Fusarium spp., | |
| | Fludionoxil | Rhizoctonia spp. | |
| | | ***Thiamethoxam is an | |
| | | insecticide | |
| Helix Xtra | Thiamethoxam | See above | See above |
| | Difenoconazole | ***Thiamethoxam is an | |
| | Metalaxyl | insecticide | |
| | Fludionoxil | | |
| Dynasty | Azoxystrobin | Pythium spp., Rhizoctonia | Corn |
| 100FS | | spp. | |
| Cruiser 250 | Combination of | Pythium spp, Phytphthora | Corn |
| | Apron XL, | spp, downy mildew, | |
| | Maxim XL, | Fusarium spp., Rhizoctonia | |
| | Dynasty | spp., Aspergillus, Penicillium, | |
| | | Phomopsis spp. | |
| Cruiser | Metalaxyl | Fusarium spp., Rhizoctonia | Soybeans, dry beans |
| Maxx Beans | Fludioxonil | spp., Pythium spp., | |
| | Thiamethoxam | Phytophthora spp., | |
| | | Phomopsis spp., | |
| | | Colletotrichum spp | |
| | | Wireworm, Seed Corn | |
| | | Maggot, European Chafer, | |
| | | Bean Leaf Beetle | |
| | | Soybean Aphid, Potato | |
| | | Leafhopper | |
| Cruiser | Difenoconazole | Pythium spp., Fusarium spp., | wheat (spring, winter, |
| Maxx | Metalaxyl-M | septoria spp., cochliobouls | durum) and barley |
| Cereals | Thiamethoxam | spp. | |
| | | Wireworm, Seed Corn | |
| | | Maggot, European Chafer, | |
| | | Bean Leaf Beetle | |
| | | Soybean Aphid, Potato | |
| | | Leafhopper | |
| FarMore | | Seed & Soil-borne fungi | Small seed vegetables |
| AVICTA | Combination of: | Rhizoctonia, Fusarium, | Cotton |
| Complete | Cruiser | Pythium, Phytophthora, | |
| Cotton | Avicta | Helminthosporium, | |
| | Dynasty | Aspergillus, Penicillium | |
| | | Nematodes, Thrips, aphid, | |
| | | fleahoppers | |
| Ag- | Streptomycin | Pseudomonas (halo blight) | Dry bean |
| Streptomycin | sulfate | | |
| Allegiance | Metalaxyl | Phytophthora spp., Pythium | Alfalfa, barley, canola, |
| FL | | spp. | chickpeas, clover, dry |
| | | | beans, rye, corn, oats, |
| | | | peas, sainfoin, sorghum, |
| | | | soybeans, sugar beets, |
| | | | vetch, wheat |
| Argent 30 | 2-(thio- | Fusarium spp., seed & | Cotton |
| | cyanatomethylthio)- | seedling rot, damping off | |
| | 1,3-benzothiazole | | |
| Baytan 30 | Triadimenol | Rhizoctonia spp., | Cereals, corn, cotton |
| Flowable | | Thielaviopsis | |
| | | Basicola, Blumeria gaminis, | |
| | | Puccini spp., Tilletia spp., | |
| | | Ustilago spp., Cochliobolus | |
| | | sativus, Fusarium spp., | |
| | | Gaeumannomyces | |
| | | garminis, Pyrenophora spp. | |
| RTU-Baytan- | Triadimenol | See Baytan & thiram | Cereals, cotton |
| Thiram | Thiram | | |
| Captan 400 | Captan | Fusarium spp., Pythium | Alfalfa, dry beans, |
| | | spp., Rhizoctonia spp | cereals, corn, cotton, |
| | | | peas, soybeans, |
| | | | cucumber, crucifers, |
| | | | sugar beets, flax, |
| | | | grasses, spinach, |
| | | | peanuts, peppers, |
| | | | sorghum, sunflower, |
| | | | squash, swiss chard |
| Crown | Carbathiin | Ascochyta, Botrytis | Chickpeas, lentils |
| | Thiabendazole | | |
| Evolve | Thiophanate- | Fusarium spp., Rhizoctonia | Potato |
| | methyl | spp Phytophthora spp., | |
| | Mancozeb | Helminthosporium solani | |
| | Cymoxanil | | |
| Gaucho CS | Imidacloprid | Fusarium spp., Pythium | Corn, canola, rapeseed, |
| FL | (insecticide) | spp., Rhizoctonia spp., | mustard |
| | | Alternaria, Blackleg | |
| | Carbathiin | Flea beetle | |
| | Thiram | | |
| Genesis XT | Imidacloprid | Fusarium spp., Rhizoctonia | Potato |
| | (insecticide) | spp. | |
| | Mancozeb | potato beetle, potato | |
| | Thiophanate | leafhopper, aphids and | |
| | | over wintering adult flea | |
| | | beetles | |
| Kodiak | Bacillus subtilis | Pythium spp., Aspergillus | Cotton, vegetables, |
| (biological | | spp. | soybean |
| fungicide) | | | |
| Prosper | Clothianidin | Fusarium spp., Pythium | Canola |
| | Carbathiin | spp., Rhizoctonia spp., | |
| | Thiram | Alternaria | |
| | Metalaxyl | | |
| Raxil-250 FL | Tebuconasole | Aspergillus, Cochliobolus, | Barley, oats, wheat |
| | | Fusarium spp., Penicillium, | |
| Raxil FL | Tebuconasole | Pytium spp., Septoria spp. | |
| Raxil MD | Tebuconasole | | |
| | Metalaxyl | | |
| Raxil T | Tebuconasole | | |
| | Thiram | | |
| Soygard | Azoxystrobin | Pythium spp., Rhizoctonia | Soybean |
| | Metalaxyl | spp | |
| Thiram | Thiram | Fungal diseases | Beets, broccoli, brussel |
| | | | sprouts, cabbage, |
| | | | carrot, cauliflower, |
| | | | celery, grasses, lettuce, |
| | | | mustard, |
| | | | pepper, radish, spinach, |
| | | | sugar beet, turnip, |
| | | | eggplant, tomato, onion, |
| | | | snap bean, dry bean, |
| | | | peas, soybeans, |
| | | | squash, pumpkin, |
| | | | watermelon, cucumber, |
| | | | cantaloupe, Sweet corn, |
| | | | alfalfa, safflower |
| Tops MZ | Thiophanate- | Fusarium spp., Rhizoctonia | Potato |
| | methyl | spp Phytophthora spp., | |
| Tops MZ- | Mancozeb | Helminthosporium solani | |
| Gaucho | | | |
| Trilex | Trifloxystrobin | Aspergillus, Fusarium | Dry bean, chickpean, |
| | | spp., Penicillium, Pytium | corn, lentil, lupin, pea, |
| | | spp., Sclerotinia spp. | peanut, popcorn, rice, |
| | | | soybean |
| Trilex | Trifloxystrobin | Aspergillus, Fusarium | Cotton |
| Advances | | spp., Penicillium, Pytium | |
| | | spp., Sclerotinia spp., | |
| | | Pythium spp., Theilaviopsis | |
| | | basicola | |
| Vitaflo 280 | Carbathiin | Botrytis, Fusarium spp., | Barley, dry beans, fall |
| | Thiram | Penicillium, Phomopsis, | rye, corn, flax, lentils, |
| | | Rhizoctonia spp., Septoria | oats, peas, snap beans, |
| | | spp., Anthracnose | soybeans, triticale, |
| | | | wheat |
| Vitavax | Carboxin | Tilletia spp., Ustilago spp., | Dry bean, cereals, |
| | | Cochliobolus sativus, | cotton, corn, grasses, |
| | | Fusarium spp., Penicillium | rice, safflower, soybean |
| | | spp., | |

Insecticides only

| | Active | | |
|---|---|---|---|
| Product | Ingredient | Organism | Crops |
| Aeris | Imidacloprid | early season thrips, aphids | Cotton |
| | Thiodicarb | and cutworms, reniform | |
| | | and root knot nematodes | |
| Ponch | Clothianidin | Rootworm, wireworm, | Corn, Canola, |
| | | cutworm, beetles, maggots, | rapeseed, |
| | | stinkbugs, grubs, thrips, | sorghum |
| | | storage pests | |
| Storcide II | Chlorpyrifos- | Beetle, borer, moth, weevil | Cereals, |
| | methyl | | rice, soybeans |
| | Deltamethrin | | |

Fungicide

| | Active | | |
|---|---|---|---|
| Product | Ingredient | Organism | Crops |
| Manex | Maneb | Fusarium spp., Pythium | Cereals, flax, corn, |
| | | spp., Rhizoctonia spp., | cotton, potato, sorghum, |
| | | Tilletia spp., Ustilago | safflower, tomato, |
| | | spp.,, Puccini spp. | grasses |

Insecticide

| Product | Active Ingredient | Organism | Crops |
|---|---|---|---|
| Dermacor | Chlorantraniliprole | Rice water weevil larvae | Rice |
| X-100 | | | |

### Example 8

A. To a clean 1000 L SS Reactor System, equipped with over-head stirrer, charge:

De-ionized water: 750 L

Start the agitation and manually charge:

Potassium Persulfate (KPS): 30 kg (110 M)
B. Agitate the mixture until KPS is dissolved.
C. In a clean, agitated 250 L Vat (Plastic or SS) prepare a mixture of:

De-ionized water: 150 L

And:

Silver Nitrate: 17.85 kg (105 M)
D. Agitate to dissolve.
E. Maintaining ambient temperature and using a metering pump, transfer the silver nitrate solution to the KPS solution contained in the 1000 L Reactor. A black precipitate will begin to form immediately.

Maintain good agitation during the addition process which should take between 30 and 45 minutes.
F. Continue to agitate the reaction mixture for an additional 1 hour.
G. Stop the stirring for 10-20 minutes and siphon off the bulk of the supernatant into a 1500 L Vat and hold for later disposal.
H. To the contents of the 1000 L Reactor add:

De-ionized water: 300 L

Agitate the mixture while preparing for filtration.

Note: since the specific weight of the product is high, the filtration equipment should be set up as closely as possible to the 1000 L Reactor System. Also, ensure that all transfer lines are self draining and avoid sharp bends which could hold up material.
I. Transfer the aqueous slurry of OxySilverNitrate onto a suitably prepared filter nutsche (pressure/agitated or box) and pull dry.

Check the pH of the filtrate.
J. Slurry wash the filter cake with ca. 15 to 20 L of water and pull dry. Repeat if the filtrate is still acidic (pH<4).
K. Discharge the filter cake to a suitable dryer (tray dryer or agitated pan dryer), determine the weight of the wet material and dry under a stream of air for 12 hours. Determine dry weight and sample for analysis.
L. Transfer the dry product to PE bags and store the product away from moisture and protected from light (e.g. in plastic kegs).

Theoretical Yield: 14.175 kg

Expected Yield: 12.75-13.45 kg (90-95% of theory)

### Example 9

The active agent of the present invention may be applied to the seeds using conventional coating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art. For example, the active ingredients can be formulated and applied as a slurry, a solid seed coating, a soak, or as a dust on the surface of the seed. There also may be mentioned, e.g., film-coating or encapsulation.

The subject combination of pesticides can be applied to a seed as a component of a seed coating. Seed coating methods and compositions that are known in the art are useful when they are modified by the addition of one of the embodiments of the combination of pesticides of the present invention. Such coating methods and apparatus for their application are disclosed in, for example, U.S. Pat. Nos. 5,918,413, 5,891,246, 5,554,445, 5,389,399, 5,107,787, 5,080,925, 4,759,945 and 4,465,017. Seed coating compositions are disclosed, for example, in U.S. Pat. Nos. 5,939,356, 5,882,713, 5,876,739, 5,849,320, 5,834,447, 5,791,084, 5,661,103, 5,622,003, 5,580,544, 5,328,942, 5,300,127, 4,735,015, 4,634,587, 4,383,391, 4,372,080, 4,339,456, 4,272,417 and 4,245,432, among others.

Among the coating techniques that may be used may be noted, but are not limited to, mixing in a container (e.g., a bottle or bag), mechanical application, tumbling, spraying, and immersion. Any conventional active or inert material can be used for contacting seeds with pesticides according to the present invention, such as conventional film-coating materials including but not limited to water-based film coating materials such as SEPIRET (Seppic, Inc., Fairfield, N.J.) and OPACOAT (Berwind Pharm. Services, Westpoint, Pa.).

In one embodiment, when coating seed on a large scale (for example a commercial scale), typically seed is introduced into the treatment equipment (such as a tumbler, a mixer, or a pan granulator) either by weight or by flow rate. The amount of treatment composition that is introduced into the treatment equipment can vary depending on the seed weight to be coated, surface area of the seed, the concentration of the active ingredient in the controlled release formulation, the desired concentration on the finished seed, and the like. The treatment composition can be applied to the seed by a variety of means, for example by a spray nozzle or revolving disc. The amount of liquid is typically determined by the assay of the formulation and the required rate of active ingredient necessary for efficacy. As the seed falls into the treatment equipment the seed can be treated (for example by misting or spraying with the seed treatment composition) and passed through the applicator under continual movement/tumbling where it can be coated evenly and dried before storage or use.

In another embodiment, a known weight of seeds can be introduced into the treatment equipment (such as a tumbler, a mixer, or a pan granulator). A known volume of seed treatment composition can be introduced into the treatment equipment at a rate that allows the seed treatment composition to be applied evenly over the seeds. During the application, the seed can be mixed, for example by spinning or tumbling. The seed can optionally be dried or partially dried during the tumbling operation. After complete coating, the treated sample can be removed to an area for further drying or additional processing, use, or storage.

In still another embodiment, seeds can be coated in laboratory size commercial treatment equipment such as a tumbler, a mixer, or a pan granulator by introducing a known weight of seeds in the treater, adding the desired amount of seed treatment composition, tumbling or spinning the seed and placing it on a tray to thoroughly dry. In another embodiment, seeds can also be coated by placing the known amount of seed into a narrow neck bottle or receptacle with a lid. While tumbling, the desired amount of seed treatment composition can be added to the receptacle. The seed is tumbled until it is coated with the seed treatment composition. After coating, the seed can optionally be dried, for example on a tray.

The pesticide formulation may be applied to the seeds using conventional coating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art.

The pesticide-treated seeds may also be enveloped with a film overcoating to protect the pesticide coating. Such overcoatings are known in the art and may be applied using conventional fluidized bed and drum film coating techniques.

In another embodiment of the present invention, a pesticide can be introduced onto or into a seed by use of solid matrix priming. For example, a quantity of the pesticide can be mixed with a solid matrix material and then the seed can be placed into contact with the solid matrix material for a period to allow the pesticide to be introduced to the seed. The seed can then optionally be separated from the solid matrix material and stored or used, or the mixture of solid matrix material plus seed can be stored or planted directly. Solid matrix materials which are useful in the present invention include polyacrylamide, starch, clay, silica, alumina, soil, sand, polyurea, polyacrylate, or any other material capable of absorbing or adsorbing the pesticide for a time and releasing that pesticide into or onto the seed.

Seeds coated with a dry mixture of hydrogel (natural or synthetic) and an active ingredient for producing a desirable effect on the seed, a plant that may emerge from the seed, or both, resists loss of coating due to abrasion encountered during handling, storage, transportation, distribution and sowing, and also provides long lasting treatment of the seed with that effect and even, if so desired, provides such treatment to the plant that later emerges from the seed.

Seeds can be soaked in an aqueous solution containing a chemical composition of the invention. Some types of seeds (e.g., soybean seeds) may be sensitive to moisture. Thus, soaking such seeds for an extended period of time may not be desirable. Seeds can be coated using a mixture of the chemical composition and melted gelatin (available from Electro Microscopy Sciences, Fort Washington, Pa.) or other commercially available materials such as that available under the trade designation MAGNA-COAT from Gustafson Co., McKinney, Tex., can be used to coat such seeds. Alternatively, a mixture of the chemical composition and a paste derived from sticky rice can be used to coat seeds. Preferably, seeds coated using such a paste are planted very soon after coating. Such compositions are typically sprayed on the seeds, although other techniques can be used such as dip coating. Another method to coat seeds involves coating the inside wall of a round container with the composition, adding seeds, then rotating the container to cause the seeds to contact the wall and the composition (referred to herein as container coating”). Seeds can be coated by combinations of coating methods.

### Example 10

The composition of the present invention can be in the form of a suspension; emulsion; slurry of particles in an aqueous medium (e.g., water); wettable powder; wettable granules (dry flowable); and dry granules.

The techniques of seed treatment application are well known to those skilled in the art, and they may be used readily in the context of the present invention.

A composition of the present invention containing an active agent may be converted into the customary formulations, such as solutions, emulsions, suspensions, powders, foams, pastes, granules, aerosols, micro-encapsulations in polymeric compounds and in coating compositions for seeds, and ULV formulations. the invention can be converted into the customary formulations, such as solutions, emulsions, suspensions, powders, foams, pastes, granules, aerosols, micro-encapsulations in polymeric compounds and in coating compositions for seeds, and ULV formulations.

The compositions can be chosen from a number of formulation types, including dustable powders, soluble powders, water soluble granules, water dispersible granules, wettable powders, granules (slow or fast release), soluble go concentrates, oil miscible liquids, ultra low volume liquids, emulsifiable concentrates, dispersible concentrates, emulsions (both oil in water and water in oil, micro-emulsions, suspension concentrates, aerosols, fogging/smoke formulations, capsule suspensions. The formulation type chosen in any instance will depend upon the particular purpose envisaged and the physical, chemical and biological properties of the compound of formula (I).

These formulations are produced in a known manner, for example by mixing the active compounds with extenders, that is liquid solvents, liquefied gases under pressure, and/or solid carriers, optionally with the use of surfactants, that is emulsifiers and/or dispersants, and/or foam formers. If the extender used is water, it is also possible to use, for example, organic solvents as auxiliary solvents.

Essentially, suitable liquid solvents include aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane, or paraffins, for example petroleum fractions, alcohols, such as butanol or glycol and also their ethers and esters, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or carriers refer to those liquids which are gaseous at normal temperature and under atmospheric pressure, for example aerosol propellants, such as halogenated hydrocarbons, and also butane, propane, nitrogen and carbon monoxide. Suitable solid carriers are: for example ground natural minerals, such as kaolins, clays, talc, chalk, quartz, attapulgite, montmorillonite or diatomaceous earth, and ground synthetic minerals, such as finely divided silica, alumina and silicates. Suitable solid carriers for granules are: for example crushed and fractionated natural rocks, such as calcite, marble, pumice, sepiolite and dolomite, or else synthetic granules of inorganic and organic meals, and granules of organic materials such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignin-sulphite waste liquors and methylcellulose.

Tackifiers, such as carboxymethylcellulose and natural and synthetic polymers, in the form of powders, granules or latices, such as gum arabic, polyvinyl alcohol and polyvinyl acetate, or else natural phospholipids, such as cephalins and lecithins and synthetic phospholipids, can be used in the formulations. Other possible additives are mineral and vegetable oils.

The gel formulations which can be used according to the invention furthermore comprise water and one or more additives. Possible additives here are all the customary components which can be employed in dressing compositions, such as, for example, dyestuffs, wetting agents, dispersing agents, emulsifiers, antifoams, preservatives, components which delay drying out, antifreezes, secondary thickeners, solvents, salts and acids.

Possible dyestuffs which can be present in the gel formulations which can be used according to the invention are all the dyestuffs customary for such purposes. Both pigments which have a low solubility in water and water-soluble dyestuffs can be used here. As examples mentioned is the dyestuffs known under the names Rhodamin B, C.I. Pigment Red 112 and C.I. Solvent Red 1.

Possible wetting agents which the gel formulations which can be used according to the invention can comprise are all the substances which are customary for the formulation of pesticides and promote wetting. Substances which can preferably be used are alkylnaphthalene-sulphonates, such as diisopropyl- or diisobutyl-naphthalene-sulphonates.

Possible dispersing agents and/or emulsifiers which the gel formulations which can be used according to the invention can comprise are all the nonionic, anionic and cationic dispersing agents customary for the formulation of pesticides. Nonionic or anionic dispersing agents or mixtures of nonionic or anionic dispersing agents can preferably be used. Suitable nonionic dispersing agents which may be mentioned are, in particular, ethylene oxide/propylene oxide block polymers, alkylphenol polyglycol ethers and tristryryiphenol polyglycol ethers and phosphated or sulphated derivatives thereof. Suitable anionic dispersing agents are, in particular, ligninsulphonates, polyarylic acid salts and arylsuiphonate-formaldehyde condensates.

Possible solvents which the gel formulations which can be used according to the invention can comprise are all the organic solvents which can be employed in pesticidal compositions. Preferred possible solvents are ketones, such as methyl isobutyl ketone and cyclohexanone, and furthermore amides, such as dimethylformamide, and moreover cyclic compounds, such as N-methyl-pyrrolidone, N-octyl-pyrrolidone, N-dodecyl-pyrrolidone, N-octyl-caprolactam, N-dodecyl-caprolactam and .gamma.-butyrolactone, and in addition strongly polar solvents, such as dimethyl sulphoxide, and furthermore aromatic hydrocarbons, such as xylene, and also esters, such as propylene glycol monomethyl ether-acetate, dibutyl adipate, hexyl acetate, heptyl acetate, tri-n-butyl citrate, diethyl phthalate and di-n-butyl phthalate, and moreover alcohols, such as ethanol, n- and i-propanol, n- and i-butanol, n- and i-amyl alcohol, benzyl alcohol and 1-methoxy-2-propanol.

Dustable powders (DP) may be prepared by mixing a compound of formula (I) with one or more solid diluents (for example natural clays, kaolin, pyrophyllite, bentonite, alumina, montmorillonite, kieselguhr, chalk, diatomaceous earths, calcium phosphates, calcium and magnesium carbonates, sulphur, lime, flours, talc and other organic and inorganic solid carriers) and mechanically grinding the mixture to a fine powder.

Soluble powders (SP) may be prepared by mixing a compound of formula (I) with one or more water-soluble inorganic salts (such as sodium bicarbonate, sodium carbonate or magnesium sulphate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

Wettable powders (WP) may be prepared by mixing a compound of formula (I) with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

Granules (GR) may be formed either by granulating a mixture of a compound of formula (I) and one or more powdered solid diluents or carriers, or from preformed blank granules by absorbing a compound of formula (I) (or a solution thereof, in a suitable agent) in a porous granular material (such as pumice, attapulgite clays, fuller's earth, kieselguhr, diatomaceous earths or ground corn cobs) or by adsorbing a compound of formula (I) (or a solution thereof, in a suitable agent) on to a hard core material (such as sands, silicates, mineral carbonates, sulphates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

Dispersible Concentrates (DC) may be prepared by dissolving a compound of formula (I) in water or an organic solvent, such as a ketone, alcohol or glycol ether. These solutions may contain a surface active agent (for example to improve water dilution or prevent crystallisation in a spray tank).

Emulsifiable concentrates (EC) or oil-in-water emulsions (EW) may be prepared by dissolving a compound of formula (I) in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO 100, SOLVESSO 150 and SOLVESSO 200; SOLVESSO is a Registered Trade Mark), ketones (such as cyclohexanone or methylcyclohexanone), alcohols (such as benzyl alcohol, furfuryl alcohol or butanol), N-alkylpyrrolidones (such as N-methylpyrrolidone or N-octylpyrrolidone), dimethyl amides of fatty acids (such as C.sub.8 C.sub.10 fatty acid dimethylamide) and chlorinated hydrocarbons. An EC product may spontaneously emulsify on addition to water, to produce an emulsion with sufficient stability to allow spray application through appropriate equipment. Preparation of an EW involves obtaining a compound of formula (I) either as a liquid (if it is not a liquid at room temperature, it may be melted at a reasonable temperature, typically below 70.degree. C.) or in solution (by dissolving it in an appropriate solvent) and then emulsifying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents that have a low solubility in water.

Microemulsions (ME) may be prepared by mixing water with a blend of one or more solvents with one or more SPAs, to produce spontaneously a thermodynamically stable isotropic liquid formulation. A compound of formula (I) is present initially in either the water or the solvent/SFA blend. Suitable solvents for use in MEs include those hereinbefore described for use in in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of a compound of formula (I). SCs may be prepared by ball or bead milling the solid compound of formula (I) in a suitable medium, optionally with one or more dispersing agents, to produce a fine particle suspension of the compound. One or more wetting agents may be included in the composition and a suspending agent may be included to reduce the rate at which the particles settle. Alternatively, a compound of formula (I) may be dry milled and added to water, containing agents hereinbefore described, to produce the desired end product.

Aerosol formulations comprise a compound of formula (I) and a suitable propellant (for example n-butane). A compound of formula (I) may also be dissolved or dispersed in a suitable medium (for example water or a water miscible liquid, such as n-propanol) to provide compositions for use in non-pressurised, hand-actuated spray pumps.

A compound of formula (I) may be mixed in the dry state with a pyrotechnic mixture to form a composition suitable for generating, in an enclosed space, a smoke containing the compound.

Capsule suspensions (CS) may be prepared in a manner similar to the preparation of EW formulations but with an additional polymerisation stage such that an aqueous dispersion of oil droplets is obtained, in which each oil droplet is encapsulated by a polymeric shell and contains a compound of formula (I) and, optionally, a carrier or diluent therefor. The polymeric shell may be produced by either an interfacial polycondensation reaction or by a coacervation procedure. The compositions may provide for controlled release of the compound of formula (I) and they may be used for seed treatment. A compound of formula (I) may also be formulated in a biodegradable polymeric matrix to provide a slow, controlled release of the compound.

The term “paste” shall be understood to mean a finely-divided resinous composition, which typically includes a plasticizer-like ingredient to form a fluid or semifluid mixture, wherein the paste is made without use of low boiling solvents or water emulsions.

### Example 11

Non-limiting examples of such chemical agents include pesticides (such as fungicides, acaricides, miticides, insecticides, insect repellants, bird repellants, rodenticides, molluscicides, nematicides, bactericides, and fumigants), herbicides, chemical hybridizing agents, auxins, antibiotics and other drugs, biological attractants, growth regulators, pheromones and dyes. Specific non-limiting examples of chemical agents useful as active ingredients include triticonazole, imidacloprid, tefluthrin, and silthiophenamide (N-allyl-4,5-dimethyl-2-trimethylsilylthiophene-3-caboxamide).

The gel formulations which can be used according to the invention comprise one or more active compounds suitable for dressing seed. Possible active compounds of this kind are all the customary fungicides, insecticides, acaricides, nematicides, plant growth regulators and bird repellents suitable for treatment of seed.

Examples of fungicides which may be mentioned here are: 2-aminobutane; 2-anilino-4-methyl-6-cyclopropyl-pyrimidine; 2′,6′-dibromo-2-methyl-4′-trifluoromethoxy-4′-trifluoromethyl-1,3-thiazole -5-carboxamide; 2,6-dichloro-N-(4-trifluoromethylbenzyl)-benzamide; (E)-2-methoximino-N-methyl-2-(2-phenoxyphenyl)-acetamide; 8-hydroxyquinoline sulphate; methyl (E)-2-{2-[6-(2-cyanophenoxy)-pyrimidin-4-yloxy]-phenyl}-3-methoxyacrylate; methyl (E)-methoximino-[alpha-(o-tolyloxy)-o-tolyl]-acetate; 2-phenylphenol (OPP), aldimorph, ampropylfos, anilazin, azaconazole, benalaxyl, benodanil, benomyl, binapacryl, biphenyl, bitertanol, blasticidin-S, bromuconazole, bupirimate, buthiobate, calcium polysulphide, captafol, captan, carbendazim, carboxin, chinomethionat (quinomethionate), chloroneb, chloropicrin, chlorothalonil, chlozolinate, cufraneb, cymoxanil, cyproconazole, cyprofuram, dichlorophen, diclobutrazol, diclofluanid, diclomezin, dicloran, diethofencarb, difenoconazole, dimethirimol, dimethomorph, diniconazole, dinocap, diphenylamine, dipyrithion, ditalimfos, dithianon, dodine, drazoxolon, edifenphos, epoxyconazole, ethirimol, etridiazol, fenarimol, fenbuconazole, fenfuram, fenitropan, fenpiclonil, fenpropidin, fenpropimorph, fentin acetate, fentin hydroxide, ferbam, ferimzone, fluazinam, fludioxonil, fluoromide, fluquinconazole, flusilazole, flusulfamide, flutolanil, flutriafol, folpet, fosetyl-aluminium, fthalide, fuberidazole, furalaxyl, furmecyclox, guazatine, hexachlorobenzene, hexaconazole, hymexazole, imazalil, imibenconazole, iminoctadin, iprobenfos (IBP), iprodion, isoprothiolan, kasugamycin, copper formulations, such as: copper hydroxide, copper naphthenate, copper oxychloride, copper sulphate, copper oxide, oxine-copper and Bordeaux mixture, mancopper, mancozeb, maneb, mepanipyrim, mepronil, metalaxyl, metconazole, methasulfocarb, methfuroxam, metiram, metsulfovax, myclobutanil, nickel dimethyldithiocarbamate, nitrothal-isopropyl, nuarimol, ofurace, oxadixyl, oxamocarb, oxycarboxin, pefurazoat, penconazole, pencycuron, phosdiphen, pimaricin, piperalin, polyoxin, probenazole, prochloraz, procymidon, propamocarb, propiconazole, propineb, pyrazophos, pyrifenox, pyrimethanil, pyroquilon, quintozen (PCNB), sulphur and sulphur formulations, tebuconazole, tecloftalam, tecnazen, tetraconazole, thiabendazole, thicyofen, thiophanat-methyl, thiram, tolclophos-methyl, tolyifluanid, triadimefon, triadimenol, triazoxide, trichlamide, tricyclazole, tridemorph, triflumizole, triforin, triticonazole, validamycin A, vinclozolin, zineb, ziram.

Examples of insecticides, acaricides and nematicides which may be mentioned are:
abamectin, abamectin, AC 303 630, acephat, acrinathrin, alanycarb, aldicarb, alphamethrin, amitraz, avermectin, AZ 60541, azadirachtin, azinphos A, azinphos M, azocyclotin, Bacillus thuringiensis, bendiocarb, benfuracarb, bensultap, betacyluthrin, bifenthrin, BPMC, brofenprox, bromophos A, bufencarb, buprofezin, butocarboxin, butylpyridaben, cadusafos, carbaryl, carbofuran, carbophenothion, carbosulfan, cartap, CGA 157419, CGA 184699, chloethocarb, chlorethoxyfos, chlorfenvinphos, chlorfluazuron, chiormephos, chlorpyrifos, chlorpyrifos M, cis-resmethrin, clocythrin, clofentezin, cyanophos, cycloprothrin, cyfluthrin, cyhalothrin, cyhexatin, cypermethrin, cyromazin, deltamethrin, demeton M, demeton S, demeton-S-methyl, diafenthiuron, diazinon, dichlofenthion, dichlorvos, dicliphos, dicrotophos, diethion, diflubenzuron, dimethoate, dimethylvinphos, dioxathion, disulfoton, edifenphos, emamectin, esfenvalerate, ethiofencarb, ethion, ethofenprox, ethoprophos, etrimphos, fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazinam, flucycloxuron, flucythrinate, flufenoxuron, flufenprox, fluvalinate, fonophos, formothion, fosthiazate, fubfenprox, furathiocarb, HCH, heptenophos, hexaflumuron, hexythiazox, imidacloprid, iprobenfos, isazophos, isofenphos, isoprocarb, isoxathion, ivemectin, lamda-cyhalothrin, lufenuron, malathion, mecarbam, mervinphos, mesulfenphos, metaldehyde, methacrifos, methamidophos, methidathion, methiocarb, methomyl, metolcarb, milbemectin, monocrotophos, moxidectin, naled, NC 184, NI 25, nitenpyram methoate, oxamyl, oxydemethon M, oxydeprofos, parathion A, parathion M, permethrin, phenthoate, phorate, phosalon, phosmet, phosphamdon, phoxim, pirimicarb, pirimiphos M, pirimiphos A, profenofos, promecarb, propaphos, propoxur, prothiofos, prothoate, pymetrozin, pyrachlophos, pyradaphenthion, pyresmethrin, pyrethrum, pyridaben, pyrimidifen, pyriproxifen, quinaiphos, RH 5992, salithion, sebufos, silafluofen, sulfotep, sulprofos, tebufenozid, tebufenpyrad, tebupirimphos, teflubenzuron, tefluthrin, temephos, terbam, terbufos, tetrachlorvinphos, thiafenox, thiodicarb, thiofanox, thiomethon, thionazin, thuringiensin, tralomethrin, triarathen, triazophos, triazuron, trichlorfon, triflumuron, trimethacarb, vamidothion, XMC, xylylcarb, zetamethrin.

Chlormequat may be mentioned as examples of a plant growth regulator in the present connection

Compositions that includes a combination of at least one pyrethrin or synthetic pyrethroid and at least one other insecticide selected from the group consisting of an oxadiazine derivative, a chloronicotinyl, a nitroguanidine, a pyrrol, a pyrazone, a diacylhydrazine, a triazole, a biological/fermentation product, a phenyl pyrazole, an organophosphate and a carbamate

The combination of insecticides that has been found to achieve such results is a combination of a pyrethrin or synthetic pyrethroid as one component, and with another component comprising one or more of certain other insecticides selected from the group consisting of an oxadiazine derivative, a chloronicotinyl, such as imidacloprid, acetamiprid, and nitenpyram; a nitroguanidine; a pyrrol, such as chlorfenapyr; a pyrazole, such as tebufenpyrad; a diacylhydrazine, such as tebufenozide, methoxyfenozide, and halofenozide; a triazole, such as triazamate; a biological/fermentation product, such as avermectin and spinosad; a phenyl pyrazole, such as fipronil; an organophosphate, such as acephate, fenamiphos, diazinon, chlorpyrifos, chlorpyrifon-methyl and malathion; and a carbamate, such as carbaryl, aldicarb, carbofuran, thiodicarb and oxamyl. It is preferred, however, that if the other insecticide is an oxadiazine derivative, the pyrethroid should be selected from the group consisting of taufluvalinate, flumethrin, trans-cyfluthrin, kadethrin, bioresmethrin, tetramethrin, phenothrin, empenthrin, cyphenothrin, prallethrin, imiprothrin, allethrin and bioallethrin.

The seeds may also be treated with one or more of the following ingredients: other pesticides, including compounds which act only below the ground; fungicides, such as captan, thiram, metalxyl, fludioxonil, oxadixyl, and isomers of each of those materials, and the like; herbicides, including compounds selected from carbamates, thiocarbamates, acetamides, triazines, dinitroanilines, glycerol ethers, pyridazinones, uracils, phenoxys, ureas, and benzoic acids; herbicidal safeners such as benzoxazine, benzhydryl derivatives, N,N-diallyl dichloroacetamide, various dihaloacyl, oxazolidinyl and thiazolidinyl compounds, ethanone, naphthalic anhydride compounds, and oxime derivatives; fertilizers; and biocontrol agents such as naturally-occurring or recombinant bacteria and fungi from the genera Rhizobium, Bacillus, Pseudomonas, Serratia, Trichoderma, Glomus, Gliocladium and mycorrhizal fungi. These ingredients may be added as a separate layer on the seed or alternatively may be added as part of the pesticide composition.

The seeds may also be treated with one or more of the following ingredients: other pesticides, including compounds which act only below the ground; fungicides, such as captan, thiram, metalxyl, fludioxonil, oxadixyl, and isomers of each of those materials, and the like; herbicides, including compounds selected from carbamates, thiocarbamates, acetamides, triazines, dinitroanilines, glycerol ethers, pyridazinones, uracils, phenoxys, ureas, and benzoic acids; herbicidal safeners such as benzoxazine, benzhydryl derivatives, N,N-diallyldichloroacetamide, various dihaloacyl, oxazolidinyl and thiazolidinyl compounds, ethanone, naphthalic anhydride compounds, and oxime derivatives; fertilizers; and biocontrol agents such as naturally-occurring or recombinant bacteria and fungi from the genera Rhizobium, Bacillus, Pseudomonas, Serratia, Trichoderma, Glomus, Gliocladium and mycorrhizal fungi. These ingredients may be added as a separate layer on the seed or alternatively may be added as part of the pesticide composition.

Among the active ingredients that are suitable for use in the practice of the present invention may be listed 5,6-dihydro-2-methyl-1,4-oxathiine-3-carboxanilide 4,4-dioxide, also known as oxycarboxin (common name) as well as by its trademark PLANTVAX.RTM.; 2,3-dihydro-2,2-dimethyl-7-benzofuranyl methyl carbamate, also known as carbofuran (its common name); methylcarbamic acid 2-(2-chloro-1-methoxy ethoxy)phenyl ester, also known as cloethocarb (its common name); 2-(4-chlorophenyl)-3-cyclopropyl-1-(1H-1,2,4-triazol-1-yl)-butan-2-ol, also known as cyprocnazole (its common name); pentachloronitrobenzene, also known as cyproconazole (its common name); pentachloronitrobenzene, also known as quintozene (common name) as well as by its trademark TERRACLOR.RTM.; 5-ethoxy-3-(trichloromethyl)-1,2,4-thiadiazole, also known as etridiazole (common name) as well as its trademark TERRAZOLE.RTM.; Rhizobium sp; Penicillium bilajii; Bacillus subtilis; .beta.-(4-chlorophenoxy)-.alpha.-(1,1-dimethylethyl)-1H-1,2,4-triazole-1- ethanol, also known as triadimenol (common name) or by its trademark BAYTAN.RTM.; tetramethylthiuram disulfide, also known as thiram (common name); 2-(4-thiazolyl)benzimidazole, also known as thiabendazole (common name) as well as its abbreviation “TBZ”; (2-methyl[1,1′-biphenyl]-3-yl)methyl-3-(2-chloro-3,3,3trifluoro-1-propeny-I)-2,2-dimethylcyclopropane-carboxylate, also known as bifenthrin (common name); 1,2,3,4,5,6-hexachlorocyclo-hexane, gamma-isomer, also known as lindane (common name); N-(2,6-dimethylphenyl)-N-(methoxyacetyl)alanine methyl ester, also known as metalaxyl (common name); 1-[(6-chloro-3-pyridinyl)methyl]-N-nitro-2-imidazolidinimine, also known as imidacloprid (common name); and .alpha.-butyl-.alpha.'-(4-chlorophenyl)-1H-1,2,4-triazole propanenitrile, also known as myclobutanil (common name).

In this regard an “active” ingredient can be a single ingredient or a combination of ingredients; and the meaning of the term “active” shall be understood to include but not be limited to the following:
(1) such arthropodicidally-active compositions-of-matter as are disclosed and listed in U.S. Pat. No. 5,093,853;
(2) such bactericidally-active compositions-of-matter as are disclosed in U.S. Pat. No. 4,182,716;
(3) such fungicidally-active compositions-of-matter as are disclosed in U.S. Pat. No. 4,182,716; U.S. Pat. No. 4,497,646; U.S. Pat. No. 4,569,690; U.S. Pat. Nos. 4,857,649 and 4,950,671; U.S. Patent Nos. 4,966,912 and 5,061,716; U.S. Pat. Nos. 5,039,332 and 5,071,862; and U.S. Pat. No. 5,215,747;
(4) such herbicidally-active compositions-of-matter as those disclosed in U.S. Pat. No. 4,497,646; U.S. Pat. Nos. 4,569,690 and 4,927,451; U.S. Pat. No. 4,945,113; U.S. Pat. No. 4,966,910; U.S. Pat. No. 4,979,982 (to Brouwer et al.; U.S. Pat. No. 4,981,508; U.S. Pat. No. 5,114,464; U.S. Pat. No. 5,169,430; and U.S. Pat. No. 5,319,102;
(5) such microbiologically-active compositions-of-matter as are disclosed in U.S. Pat. No. 5,215,747;
(6) such pesticidally-active compositions-of-matter as those disclosed in U.S. Pat. No. 4,839,349; U.S. Pat. No. 5,010,068; U.S. Pat. No. 5,134,133; and U.S. Pat. Nos. 5,134,144 and 5,134,145; and
(7) such plant growth regulant-active compositions-of-matter as those disclosed in U.S. Pat. No. 4,319,033; U.S. Pat. No. 4,857,649; U.S. Pat. No. 4,943,309; U.S. Pat. No. 5,039,332; U.S. Pat. No. 5,070,211; and U.S. Pat. No. 5,176,735.

Examples of fungicidal compounds which may be included in the composition of the invention are AC 382042 (N-(1-cyano-1,2-dimethylpropyl)-2-(2,4-dichlorophenoxy)propionamide), acibenzolar-S-methyl, alanycarb, aldimorph, anilazine, azaconazole, azafenidin, azoxystrobin, benalaxyl, benomyl, benthiavalicarb, biloxazol, bitertanol, blasticidin S, boscalid (new name for nicobifen), bromuconazole, bupirimate, captafol, captan, carbendazim, carbendazim chiorhydrate, carboxin, carpropamid, carvone, CGA 41396, CGA 41397, chinomethionate, chlorbenzthiazone, chlorothalonil, chlorozolinate, clozylacon, copper containing compounds such as copper oxychloride, copper oxyquinolate, copper sulphate, copper tallate, and Bordeaux mixture, cyamidazosulfamid, cyazofamid (IK-916), cyflufenamid, cymoxanil, cyproconazole, cyprodinil, debacarb, di-2-pyridyl disulphide 1,1′-dioxide, dichlofluanid, diclocymet, diclomezine, dicloran, diethofencarb, difenoconazole, difenzoquat, diflumetorim, O,O-di-iso-propyl-S-benzyl thiophosphate, dimefluazole, dimetconazole, dimethirimol, dimethomorph, dimoxystrobin, diniconazole, dinocap, dithianon, dodecyl dimethyl ammonium chloride, dodemorph, dodine, doguadine, edifenphos, epoxiconazole, ethaboxam, ethirimol, ethyl (Z)-N-benzyl N([methyl(methylthioethylideneaminooxycarbonyl)amino]thio)-.- beta.-alaninate, etridiazole, famoxadone, fenamidone, fenarimol, fenbuconazole, fenfuram, fenhexamid, fenoxanil (AC 382042), fenpiclonil, fenpropidin, fenpropimorph, fentin acetate, fentin hydroxide, ferbam, fefimzone, fluazinam, fludioxonil, flumetover, flumorph, fluoroimide, fluoxastrobin, fluquinconazole, flusilazole, flusulfamide, flutolanil, flutriafol, folpet, fosetyl-aluminium, fuberidazole, furalaxyl, furametpyr, guazatine, hexaconazole, hydroxyisoxazole, hymexazole, imazalil, imibenconazole, iminoctadine, iminoctadine triacetate, ipconazole, iprobenfos, iprodione, iprovalicarb, isopropanyl butyl carbamate, isoprothiolane, kasugamycin, kresoxim-methyl, LY186054, LY211795, LY 248908, mancozeb, maneb, mefenoxam, mepanipyrim, mepronil, metalaxyl, metalaxyl M, metconazole, metiram, metiram-zinc, metominostrobin, metrafenone, MON65500 (N-allyl-4,5-dimethyl-2-trimethylsilylthiophene-3-carboxamide), myclobutanil, NTNO301, neoasozin, nickel dimethyldithiocarbamate, nitrothale-isopropyl, nuarimol, ofurace, organomercury compounds, orysastrobin, oxadixyl, oxasulfuron, oxolinic acid, oxpoconazole, oxycarboxin, pefurazoate, penconazole, pencycuron, phenazin oxide, phosphorus acids, phthalide, picoxystrobin, polyoxin D, polyram, probenazole, prochloraz, procymidone, propamocarb, propamocarb hydrochloride, propiconazole, propineb, propionic acid, proquinazid, prothioconazole, pyraclostrobin, pyrazophos, pyrifenox, pyrimethanil, pyroquilon, pyroxyfur, pyrrolnitrin, quaternary ammonium compounds, quinomethionate, quinoxyfen, quintozene, silthiofam (MON 65500), S-imazalil, simeconazole, sipconazole, sodium pentachlorophenate, spiroxamine, streptomycin, sulphur, tebuconazole, tecloftalam, tecnazene, tetraconazole, thiabendazole, thifluzamide, 2-(thiocyanomethylthio)benzothiazole, thiophanate-methyl, thiram, tiadinil, timibenconazole, tolclofos-methyl, tolylfluanid, triadimefon, triadimenol, triazbutil, triazoxide, tricyclazole, tridemorph, trifloxystrobin, triflumizole, triforine, triticonazole, validamycin A, vapam, vinclozolin, XRD-563, zineb, ziram, and zoxamide.

Other suitable fungicidal compounds that may mentioned are Benomyl (also known as Benlate), Bitertanol, Carbendazim, Capropamid, Cymoxanil, Cyprodinil, Ethirimol, Fenpiclonil, Fenpropimorph, Fluquinconazole, Flutolanil, Flutriafol, Fosetyl-aluminum, Fuberidazole, Guazatine, Hymexanol, Kasugamycin, Imazalil, Imibenconazole, Iminoctadine-triacetate, Ipconazole, Iprodione, Mancozeb, Maneb, Mepronil, Metalaxyl, Metalaxyl-M (Mefenoxam), Metconazole, Metiram, MON 65500 (Silthiopham-ISO proposed), Myclobutanil, Nuarimol, Oxadixyl, Oxine-copper, Oxolinic acid, Pefurazoate, Pencycuron, Prochloraz, Propamocarb hydrochloride, Pyroquilon, Silthiopham—see MON 65500, Tecnazene, Thifluzamide, Thiophenate-methyl, Tolclofos-methyl, Triadimenol, Triazoxide and Triflumizole.

In one embodiment, the aqueous fungicidal compositions of the invention can be prepared by a process which comprises the steps: (a) forming a premix with at least one solid fungicidally active compound and at least one surfactant; (b) forming a premix of a carrier and water, and (c) sequentially adding the premixes (a) and (b) and the remaining ingredients to water while stirring to form a homogeneous composition.

In one aspect, the solid fungicidally active compounds may be wet milled prior to being added to the mixture (c).

### Example 12

AGRESS® SEED TREATMENT fungicide and Bactericide is a ready-to-use seed treatment formulation containing silver oxide. AGRESS® SEED TREATMENT fungicide and bactericide controls or suppresses certain seed-borne diseases in pulses and legume crops.

For every 100 kg of seed to be treated, pre-mix AGRESS® SEED TREATMENT in water at a rate of 0.1% (0.5 g AGRESS® in 0.5-L). Prepare suspension by mixing with water for 30 minutes. ALWAYS PREPARE FRESH SOLUTIONS-DO NOT STORE SOLUTIONS FOR MORE THAN 8-hr. If the volume of water is increased, add AGRESS® SEED TREATMENT to maintain a 0.1% suspension. ENSURE PRODUCT IS APPLIED TO THE SEEDS AS A SUSPENSION.

Note: AGRESS® powder is not completely soluble in water therefore, some of the powder will remain suspended in water.

Add the suspension to seed as it is being gently tumbled. Ensure even coverage. Allow seed to dry prior to planting.

| AGRESS ® SEED TREATMENT | Water | Seed Treated |
|---|---|---|
| 0.5-g | 0.5-L | 100-kg |

DISEASES CONTROLLED: AGRESS ® SEED TREATMENT is
a fungicide and bactericide that will generally eradicate seed-borne
bacterial and fungal diseases caused by pathogens listed below.
Use 0.5-g of AGRESS ® in 0.5-L of water for control each
of the following diseases:
SEED-BORNE BACTERIAL DISEASES

| | | |
|---|---|---|
| A. Dry Bean | Halo blight of dry bean | Pseudomonas syringae |
| | | pv. phaseolicola |
| | Brown spot of dry bean | Pseudomonas syringae |
| | | pv. syringae |
| | Common blight of dry bean | Xanthomonas |
| | | axonopodis |
| | | pv. phaseoli |
| | Bacterial wilt of dry bean | Curtobacterium |
| | | flaccumfacines |
| | | pv. flaccumfaciens |
| B. Field Pea | Bacterial blight of dry/field pea | Pseudomonas syringae |
| | | pv. pisi |
| C. Soybean | Bacterial blight of soybean | Pseudomonas savastonoi |
| | | pv. glycines |
| | Bacterial pustule of soybean | Xanthomonas |
| | | axonopodis |
| | | pv. glycines |
| D. Chickpea | Bacterial leaf spot of chickpea | Pseudomonas |
| | | andropogonis |

SEED-BORNE FUNGAL DISEASES

| | | |
|---|---|---|
| A. Dry Bean | Anthracnose of dry bean | Colletotrichum |
| | | lindemuthianum |
| B. Lentil | Anthracnose of lentil | Colletotrichum |
| | | truncatum |
| C. Field Pea | Anthracnose of dry/field pea | Colletotrichum |
| | | gloeosporoides |
| | | Colletotrichum pisi |
| D. Soybean | Anthracnose of soybean | Colletotrichum |
| | | truncatum |

1. A method for improving the germination rate or speed of a seed, comprising contacting said seed with an agent comprising at least one form of high valency silver.

2. The method of claim 1 wherein said agent is an anti-biofilm agent.

3. The method of claim 2 wherein said biofilm is from a microorganism selected from the group consisting of Pseudomonas ssp., Xanthomonas ssp., Curtobacterium ssp., Fusarium ssp., Rhizoctonia spp., Pythium ssp., Phytophthora spp., Aspergillus ssp., and variants thereof.

4. The method of claim 1 further comprising contacting said seed with an at least one additional active agent.

5. The method of claim 4 wherein the active agent is selected from one or more agents comprising an antimicrobial agent, a fungicide, a preservative, a viricide, a parasiticide, an insecticide, a bactericide, a bacteristatic agent, a pesticide, and a chemical agent.

6. The method of claim 1 wherein said at least one form of high valency silver comprises an at least one form of stable soluble silver ion selected from the group consisting of Ag++ and Ag+++.

7. The method of claim 6 wherein said at least one form of a high valency silver comprises oxysilver nitrate, silver periodate, silver (II) biguanide, silver (III) biguanide, or combinations thereof.

8. The method of claim 1 wherein contacting the seed comprises contacting a soil or growth medium intended to receive the seed.

9. A composition for improving the germination rate or speed of a seed comprising a composition comprising at least one form of high valency silver.

10. The composition of claim 9 wherein the composition is a powder, or an aqueous suspension or solution of high valency silver ions.

11. The composition of claim 9 wherein the composition is a solution of high valency silver ions.

12. The composition of claim 10 wherein the composition includes silver periodate.

13. The composition of claim 9 wherein the composition comprises oxysilver nitrate, silver periodate, silver (II) biguanide, silver (III) biguanide, silver II oxide, or combinations thereof.

14. The composition of claim 9 further comprising at least one additional active agent.

15. The composition of claim 14 wherein the additional active agent is selected from the group consisting of an antimicrobial agent, a fungicide, a preservative, a viricide, a parasiticide, an insecticide, a bactericide, a bacteristatic agent, a pesticide, and a chemical agent.
